(19) United States
(12) Patent Application Publication
(10) Pub. No.: US 2025/0182289 A1
(43) Pub. Date: Jun. 5, 2025

(54) IMAGE PREPROCESSING DEVICE AND IMAGE PREPROCESSING METHOD

(71) Applicants: Samsung Display Co., LTD., Yongin-si (KR); Seoul National University R&DB Foundation, Seoul (KR)

(72) Inventors: Kyu Su AHN, Yongin-si (KR); Jae Jin LEE, Seoul (KR); Byeong Hyun KO, Incheon (KR); Chan Woo PARK, Seoul (KR); Hyun Gyu LEE, Seoul (KR)

(73) Assignees: Samsung Display Co., LTD., Yongin-si (KR); Seoul National University R&DB Foundation, Seoul (KR)

(21) Appl. No.: 18/897,370

(22) Filed: Sep. 26, 2024

(30) Foreign Application Priority Data
Nov. 30, 2023 (KR) 10-2023-0171436

(51) Int. Cl. G06T 7/11

(52) U.S. Cl. CPC G06T 7/11; G06T 2207/20081; G06T 2207/20132

(57) ABSTRACT

An image data pair for image restoration training is generated by an image preprocessing method. The image preprocessing method includes receiving first image data and second image data, generating reference image data based on the first image data, generating a plurality of crop image data based on the second image data, selecting crop image data based on a smallest loss function value among loss function values generated based on each of the reference image data and the plurality of crop image data, and outputting the reference image data and the selected crop image data as the image data pair.

### CROSS REFERENCE TO RELATED APPLICATION(S)

This application claims priority to and benefits of Korean Patent Application No. 10-2023-0171436 under 35 U.S.C. § 119, filed on Nov. 30, 2023, the entire content of which are incorporated herein by reference.

### BACKGROUND

### 1. Technical Field

Embodiments relate to an image preprocessing device and an image preprocessing method.

### 2. Description of the Related Art

An electronic device such as a mobile device is released in various sizes according to a function and a user's preference, and may include a large-screen touch display for ensuring wide visibility and convenience of an operation. The electronic device may include at least one camera module such as image sensor. For example, the electronic device may include at least one under-display camera (UDC) disposed under or below a display. A general electronic device includes a display area and a camera area, and since a display is not driven in the camera area, a partial area of the display cannot display a screen. On the other hand, an electronic device, to which the UDC is applied, may display a screen in the entire display area because the display is driven also in the camera area such as a UDC area.

### SUMMARY

Embodiments provide an image preprocessing device and an image preprocessing method capable of providing image data for more improved image restoration training to an image restoration module.

According to an embodiment, an image data pair for image restoration training may be generated by an image preprocessing method. The image preprocessing method may include receiving first image data and second image data, generating reference image data based on the first image data, generating a plurality of crop image data based on the second image data, selecting crop image data based on a smallest loss function value among loss function values generated based on each of the reference image data and the plurality of crop image data, and outputting the reference image data and the selected crop image data as the image data pair.

In an embodiment, the loss function values may be calculated by Equation 1 below.

$$L 1 ( D 1 , D 2 ) = {\sum }_{x = 1}^{N} {\sum }_{y = 1}^{M} {( D 1 ( x , y ) - D 2 ( x , y ) )}^{2}$$

Here, D1 may indicate the reference image data, D2 may indicate one of the plurality of crop image data, M may indicate a height of the reference image data, N may indicate a width of the reference image data, D1(x,y) may indicate a data value of coordinates (x, y) in the reference image data, D2(x,y) may indicate a data value of the coordinates (x, y) in one of the plurality of crop image data, L1(D1,D2) may indicate a loss function value generated based on one of the reference image data and the plurality of crop image data, and M and N may be natural numbers of 2 or more.

In an embodiment, the loss function values may be calculated by Equation 2 below.

$$L 2 ( D 1 , D 2 ) = {\sum }_{u = 1}^{N} {\sum }_{v = 1}^{M} \vert {F}_{D 1} ( u , v ) - {F}_{D 2} ( u , v ) \vert$$

Here, D1 may indicate the reference image data, D2 may indicate one of the plurality of crop image data, M may indicate a height of the reference image data, N may indicate a width of the reference image data, F_{D1}(u,v) may indicate a data value of coordinates (u, v) in Fourier transform of the reference image data, F_{D2}(x,y) may indicate a data value of the coordinates (u, v) in the Fourier transform of one of the plurality of crop image data, L2(D1,D2) may indicate a loss function value generated based on one of the reference image data and the plurality of crop image data, and M and N may be natural numbers of 2 or more.

In an embodiment, the loss function values may be calculated by Equation 3 below.

$$L 3 ( D 1 , D 2 ) = {\sum }_{u = 1}^{N} {\sum }_{v = 1}^{M} \vert ∠ {F}_{D 1} ( u , v ) - ∠ {F}_{D 2} ( u , v ) \vert$$

Here, D1 may indicate the reference image data, D2 may indicate one of the plurality of crop image data, M may indicate a height of the reference image data, N may indicate a width of the reference image data, F_{D1}(u,v) may indicate a data value of coordinates (u, v) in Fourier transform of the reference image data, F_{D2}(x,y) may indicate a data value of the coordinates (u, v) in the Fourier transform of one of the plurality of crop image data, L3(D1,D2) may indicate a loss function value generated based on one of the reference image data and the plurality of crop image data, and M and N may be natural numbers of 2 or more.

In an embodiment, the loss function values may be calculated by Equation 4 below.

$$L 4 ( D 1 , D 2 ) = {λ}_{1} \cdot L 1 ( D 1 , D 2 ) + {λ}_{2} \cdot L 2 ( D 1 , D 2 ) + {λ}_{3} \cdot L 3 ( D 1 , D 2 )$$

Here, D1 may indicate the reference image data, D2 may indicate one of the plurality of crop image data, M may indicate a height of the reference image data, N may indicate a width of the reference image data, D1(x,y) may indicate a data value of coordinates (x, y) in the reference image data, D2(x,y) may indicate a data value of the coordinates (x, y) in one of the plurality of crop image data, F_{D1}(u,v) may indicate a data value of coordinates (u, v) in Fourier transform of the reference image data, F_{D2}(x,y) may indicate a data value of the coordinates (u, v) in the Fourier transform of one of the plurality of crop image data, L3(D1,D2) may indicate a loss function value generated based on one of the reference image data and the plurality of crop image data, M and N may be natural numbers of 2 or more, and each of λ₁, λ₂, and λ₃ may be a selected real number.

In an embodiment, the selecting of the crop image data based on the smallest loss function value among the loss function values generated based on each of the reference image data and the plurality of crop image data may include initializing a temporary loss function value, a horizontal movement values, and a vertical movement value, calculating the loss function value based on the reference image data and crop image data corresponding to given horizontal movement value and vertical movement value among the plurality of crop image data, and determining whether the calculated loss function value is less than the temporary loss function value.

In an embodiment, the selecting of the crop image data based on the smallest loss function value among the loss function values generated based on each of the reference image data and the plurality of crop image data may further include updating the temporary loss function value with the calculated loss function value in case that the calculated loss function value is less than the temporary loss function value, and designating a horizontal movement value and a vertical movement value corresponding to the calculated loss function value as a temporary position value.

In an embodiment, the selecting of the crop image data based on the smallest loss function value among the loss function values generated based on each of the reference image data and the plurality of crop image data may further include increasing the horizontal movement value by a first unit length in case that the horizontal movement value does not reach a maximum value, increasing the vertical movement value by a unit length, and calculating the loss function value based on the reference image data and crop image data corresponding to given horizontal movement value and vertical movement value among the plurality of crop image data.

In an embodiment, the selecting of the crop image data based on the smallest loss function value among the loss function values generated based on each of the reference image data and the plurality of crop image data may further include initializing the horizontal movement value in case that the horizontal movement value reaches a maximum value.

In an embodiment, the selecting of the crop image data based on the smallest loss function value among the loss function values generated based on each of the reference image data and the plurality of crop image data may further include increasing the vertical movement value by a second unit length in case that the vertical movement value does not reach a maximum value, and calculating the loss function value based on the reference image data and crop image data corresponding to given horizontal movement value and vertical movement value among the plurality of crop image data.

In an embodiment, the selecting of the crop image data based on the smallest loss function value among the loss function values generated based on each of the reference image data and the plurality of crop image data may further include selecting crop image data corresponding to the temporary position value in case that the vertical movement value reaches a maximum value.

In an embodiment, the selecting of the crop image data based on the smallest loss function value among the loss function values generated based on each of the reference image data and the plurality of crop image data may include initializing a temporary loss function value, a rotation angle, a horizontal movement value, and a vertical movement value, calculating the loss function value based on the reference image data and crop image data corresponding to given rotation angle, horizontal movement value, and vertical movement value among the plurality of crop image data, and determining whether the calculated loss function value is less than the temporary loss function value.

In an embodiment, the selecting of the crop image data based on the smallest loss function value among the loss function values generated based on each of the reference image data and the plurality of crop image data may further include updating the temporary loss function value with the calculated loss function value in case that the calculated loss function value is less than the temporary loss function value, and designating a rotation angle, a horizontal movement value, and a vertical movement value corresponding to the calculated loss function value as a temporary position value.

In an embodiment, the selecting of the crop image data based on the smallest loss function value among the loss function values generated based on each of the reference image data and the plurality of crop image data may further include increasing the horizontal movement value by a first unit length in case that the horizontal movement value does not reach a maximum value, increasing the vertical movement value by a unit length, and calculating the loss function value based on the reference image data and crop image data corresponding to given horizontal movement value and vertical movement value among the plurality of crop image data.

In an embodiment, the selecting of the crop image data based on the smallest loss function value among the loss function values generated based on each of the reference image data and the plurality of crop image data may further include initializing the horizontal movement value in case that the horizontal movement value reaches a maximum value.

In an embodiment, the selecting of the crop image data based on the smallest loss function value among the loss function values generated based on each of the reference image data and the plurality of crop image data may further include increasing the vertical movement value by a second unit length in case that the vertical movement value does not reach a maximum value, and calculating the loss function value based on the reference image data and crop image data corresponding to given horizontal movement value and vertical movement value among the plurality of crop image data.

In an embodiment, the selecting of the crop image data based on the smallest loss function value among the loss function values generated based on each of the reference image data and the plurality of crop image data may further include initializing the vertical movement value in case that the vertical movement value reaches a maximum value.

In an embodiment, the selecting of the crop image data based on the smallest loss function value among the loss function values generated based on each of the reference image data and the plurality of crop image data may further include increasing the rotation angle by a unit angle in case that the rotation angle does not reach a maximum value, and calculating the loss function value based on the reference image data and crop image data corresponding to given horizontal movement value and vertical movement value among the plurality of crop image data.

In an embodiment, the selecting of the crop image data based on the smallest loss function value among the loss function values generated based on each of the reference image data and the plurality of crop image data may further include selecting crop image data corresponding to the temporary position value in case that the rotation angle reaches a maximum value.

In accordance with an image preprocessing device and an image preprocessing method according to the disclosure, image data for more improved image restoration training may be provided to an image restoration module.

### BRIEF DESCRIPTION OF THE DRAWINGS

The above and other features of the disclosure will become more apparent by describing in further detail embodiments thereof with reference to the accompanying drawings, in which:

FIG. 1 is a schematic diagram illustrating an embodiment of a mobile device equipped with an under-display camera;

FIG. 2 is a schematic diagram illustrating a display pattern on the under-display camera of FIG. 1;

FIG. 3 is a schematic diagram illustrating an embodiment of a mobile device equipped with a camera module for reference image capturing for training of an image restoration module;

FIG. 4 is a schematic diagram illustrating an embodiment of an image data obtainment device for training of the image restoration module;

FIG. 5 is a schematic block diagram illustrating a system for training the image restoration module using first and second image data;

FIG. 6 is a schematic block diagram illustrating a method of recovering deteriorated image data using a trained image restoration module;

FIG. 7 is a schematic diagram illustrating another embodiment of an image data obtainment device for training of the image restoration module;

FIGS. 8A and 8B are schematic diagrams illustrating an embodiment of a pattern mount unit included in the image data obtainment device;

FIGS. 9A and 9B are schematic cross-sectional views of the pattern mount unit shown in FIGS. 8A and 8B, respectively;

FIG. 10 is a schematic block diagram illustrating a system for training the image restoration module using the image data obtainment device shown in FIGS. 7 to 9B;

FIG. 11 is a schematic diagram illustrating a difference between the first and second image data obtained by the image obtainment device of FIG. 4;

FIG. 12A is a schematic diagram illustrating the first image data generated by a first camera module of FIG. 11;

FIG. 12B is a schematic diagram illustrating the second image data generated by a second camera module of FIG. 11;

FIG. 13 is a schematic block diagram illustrating an operation of an image preprocessing device according to an embodiment;

FIG. 14 is a schematic block diagram illustrating a method of recovering deteriorated image data using the image restoration module trained by restoration training of FIG. 13;

FIGS. 15A, 15B, 15C, 15D, 15E, and 15F are schematic diagrams illustrating an operation of an image preprocessing device according to an embodiment;

FIG. 16 is a schematic diagram illustrating an operation of an image preprocessing device according to an embodiment;

FIG. 17 is a flowchart illustrating a method of operating an image preprocessing device according to an embodiment;

FIG. 18A is a flowchart illustrating an embodiment of a step S140 of FIG. 17;

FIG. 18B is a block diagram illustrating an embodiment of an image preprocessor according to an embodiment;

FIG. 19 is another schematic diagram illustrating the difference between the first and second image data obtained by the image obtainment device of FIG. 4;

FIG. 20A is a schematic diagram illustrating first image data generated by a first camera module of FIG. 19;

FIG. 20B is a diagram illustrating second image data generated by a second camera module of FIG. 19;

FIGS. 21A, 21B, 21C, 21D, 21E, 21F, and 21G are schematic diagrams illustrating an operation of an image preprocessing device according to an embodiment; and

FIG. 22 is a flowchart illustrating another embodiment of the step S140 of FIG. 17.

### DETAILED DESCRIPTION OF THE EMBODIMENT

In the following description, for the purposes of explanation, numerous specific details are set forth in order to provide a thorough understanding of various embodiments or implementations of the invention. As used herein, “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the scope of the invention.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element or a layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the axis of the first direction DR1, the axis of the second direction DR2, and the axis of the third direction DR3 are not limited to three axes of a rectangular coordinate system, such as the X, Y, and Z-axes, and may be interpreted in a broader sense. For example, the axis of the first direction DR1, the axis of the second direction DR2, and the axis of the third direction DR3 may be perpendicular to one another, or may represent different directions that are not perpendicular to one another. For the purposes of this disclosure, “at least one of A and B” may be understood to mean A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein should be interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the invention. Further, the blocks, units, and/or modules of some embodiments may be physically combined into more complex blocks, units, and/or modules without departing from the scope of the invention.

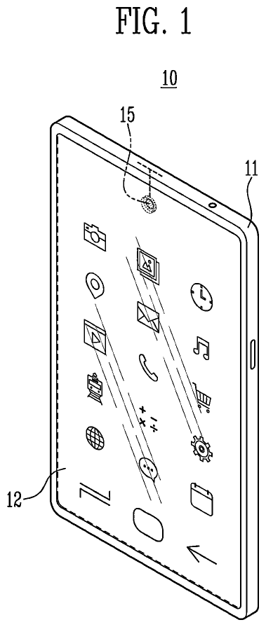

FIG. 1 is a schematic diagram illustrating an embodiment of a mobile device equipped with an under-display camera.

Referring to FIG. 1, the mobile device 10 may include a housing 11, a display panel 12 coupled to the housing 11, and a camera module 15. As an embodiment, the camera module 15 may be disposed under the display panel 12 or inside the display panel 12. For example, in case that the camera module 15 is disposed in an under-display camera (UDC) method, an area corresponding to an upper portion of the camera module 15 in the display panel 12 may display an image.

In an under-display camera, since light is required to enter a lens of a camera through the display panel, a transmittance of the light entering the camera module 15 may be reduced. For example, an opaque area having a certain pattern arrangement on the display panel may partially further reduce the transmittance of the entering light.

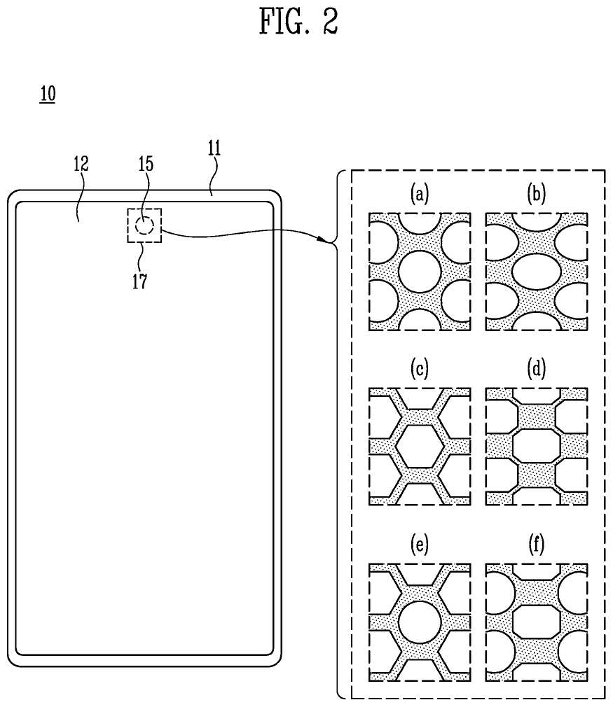

FIG. 2 is a schematic diagram illustrating a display pattern on the under-display camera of FIG. 1.

Referring to FIG. 2, the mobile device 10 including the camera module 15 disposed in a form of the under-display camera is shown. As described above, the mobile device 10 may include the housing 11, the display panel 12 coupled to the housing 11, and the camera module 15. For example, the display panel 12 may include a pattern area 17 on the camera module 15. In an embodiment, in case that the camera module 15 is not operated, the display panel 12 may display an image on the pattern area 17, and in case that the camera module 15 is operated, the display panel 12 may display an image on the pattern area 17.

For example, the pattern area 17 may also include a pattern for displaying an image equally or similarly to a remaining area of the display panel 12. As an example, the pattern area 17 on the camera module 15 may include regular and certain patterns (a), (b), (c), (d), (e), and (f) of FIG. 2. However, the patterns (a) to (f) of FIG. 2 are examples, and the pattern formed in the pattern area 17 in the display panel 12 may include regular or irregular patterns.

Each of the patterns (a), (b), (c), (d), (e), and (f) of FIG. 2 may include an opaque area, and thus a diffraction phenomenon by patterns may occur in light passing through the pattern area 17. For example, the opaque area included in the patterns (a), (b), (c), (d), (e), and (f) of FIG. 2 may reduce an amount of light incident on the camera module 15. Accordingly, image data captured by the camera module 15 disposed in the under-display method may appear with deteriorated image quality.

An image restoration module may be used to recover image data with deteriorated image quality. In an embodiment, the image restoration module may restore the image data with deteriorated image quality so that the image data with deteriorated image quality is close to an original capturing object using a deep learning algorithm. Deep learning may be a field of machine learning and may be a method of learning data through successive layers of an artificial neural network. In case of implementing the image restoration module using a deep learning technique, a sufficiently large amount of data set may be required. As an example, for the deep learning technique for recovering image data, an image data pair that pairs image data with deteriorated image quality and image data having good quality which is not deteriorated may be required. Since the image data with deteriorated image quality may be obtained through the camera module 15 of the mobile device shown in FIGS. 1 and 2, an additional device for obtaining the image data having good quality may be required.

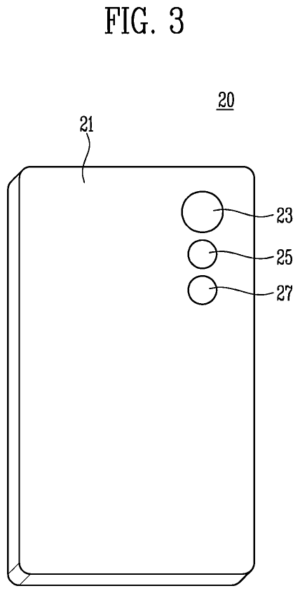

FIG. 3 is a schematic diagram illustrating an embodiment of a mobile device equipped with a camera module for reference image capturing for training of an image restoration module.

Referring to FIG. 3, the mobile device 20 may include a housing 21 and camera modules 23, 25, and 27. The camera modules 23, 25, and 27 may have different view angles and resolutions. However, this is an example, and the mobile device may include a single camera module. For example, the mobile device 20 may include a display panel. The display panel may be mounted on a surface opposite to a surface where the camera modules 23, 25, and 27 are provided. For example, the camera modules 23, 25, and 27 may be formed as a general camera other than an under-display camera. The image data having good quality which is not deteriorated by the display pattern may be obtained using one of the camera modules 23, 25, and 27. As an example, in case that the camera module 15 among the camera modules 23, 25, and 27 has the smallest view angle difference with the camera module 15 formed as the under-display camera, the image data having good quality for configuring the image data pair may be obtained using the camera module 15.

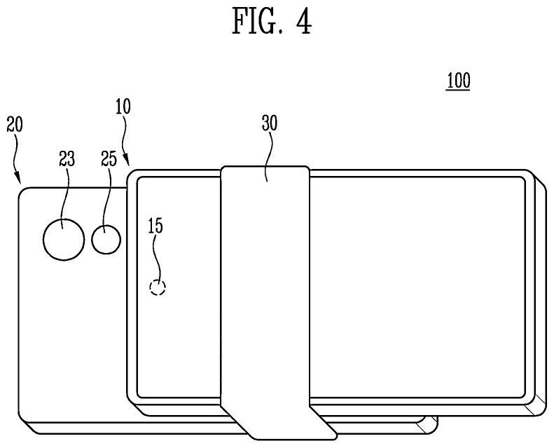

FIG. 4 is a schematic diagram illustrating an embodiment of an image data obtainment device 100 for training of the image restoration module.

Referring to FIG. 4, the image data obtainment device 100 may include a plurality of mobile devices 10 and 20. The camera module 15 of the mobile device 10 may be the under-display camera, and may obtain deteriorated image data by the camera module 15. For example, the camera module 25 of the mobile device 20 may be formed as the general camera other than the under-display camera, and may obtain the image data having good quality which is not deteriorated. In this specification, the image data having good quality which is not deteriorated is referred to as first image data, and the image data deteriorated by the display pattern is referred to as second image data.

In an embodiment, the image data obtainment device 100 may include a fixing unit 30 for coupling and fixing the mobile devices 10 and 20. The fixing unit 30 may couple the mobile devices 10 and 20 to each other while the camera modules 15 and 25 of the respective mobile devices 10 and 20 obtain image data.

As an embodiment, in order to reduce a view angle difference between the first image data and the second image data, the fixing unit 30 may fix the mobile devices 10 and 20 so that the camera module 25 of the mobile device 20 and the camera module 15 of the mobile device 10 may be positioned as close as possible.

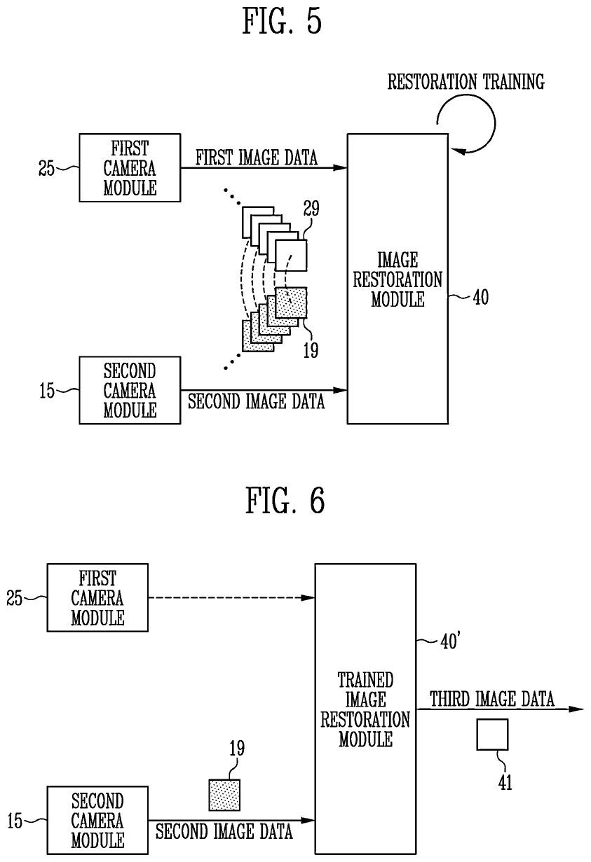

FIG. 5 is a schematic block diagram illustrating a system for training the image restoration module using the first and second image data 29 and 19 obtained by first and second camera modules 25 and 15, respectively.

Referring to FIG. 5, the first camera module 25 may obtain first image data 29 and transmit the first image data 29 to an image restoration module 40. The first camera module 25 may be formed as the general camera other than the under-display camera, and may obtain the first image data 29 which is the image data having good quality which is not deteriorated, through a capturing operation.

For example, the second camera module 15 may be formed as the under-display camera and may obtain second image data 19 which is the image data deteriorated by the pattern area 17 of the display panel. For example, each of a plurality of first image data 29 may configure (or form) the image data pair with a corresponding second image data 19 among a plurality of second image data 19. For example, the first and second image data 29 and 19 may be transmitted to the image restoration module 40 in the form of the image data pair. In an embodiment, the image restoration module 40 may be connected to the mobile devices 10 and 20 through a communication cable. In case that the first camera module 25 and the second camera module 15 obtain the first image data 29 and the second image data 19, respectively, the first image data 29 and the second image data 19 may be transmitted to the image restoration module 40 in real time.

In another embodiment, the first image data 29 and the second image data 19 obtained by the first camera module 25 and the second camera module 15 may be stored in a storage medium included in each of the mobile devices 20 and 10. Thereafter, the first image data 29 and the second image data 19 stored in the storage medium may be transmitted to the image restoration module 40.

The image restoration module 40 may perform restoration training based on the received first and second image data 29 and 19. As described above, the image restoration module 40 may perform the restoration training through deep learning using a plurality of image data pairs.

FIG. 6 is a schematic block diagram illustrating a method of recovering deteriorated image data using a trained image restoration module.

Referring to FIG. 6, the second image data 19 generated by capturing of the second camera module 15 may be transmitted to a trained image restoration module 40′. The image restoration module 40′ may be in a trained state using a large amount of image data pairs as described with reference to FIG. 5, and may generate third image data 41 by recovering the received second image data 19. The third image data 41 may have image quality equal to or comparable to that of the first image data generated by the first camera module 25.

Referring to FIGS. 3 to 6, the restoration training may be performed through deep learning using an image data pair generated by different camera modules. For example, the camera modules may have different specifications. For example, view angles or resolutions of the first and second camera modules 25 and 15 shown in FIG. 4 may be different from each other. For example, since each of the first and second camera modules 25 and 15 does not capture an object OBJ at the same position, a parallax may exist between the first and second camera modules 25 and 15. For example, a field of view FOV1 of the first camera module 25 and a field of view FOV2 of the second camera module 15 may be different from each other. Accordingly, a capture area of the third image data 41 generated by the first camera module 25 and a capture area of the second image data 19 generated by the second camera module 15 may become different from each other. In contrast, the deteriorated image data and the image data having good quality which is not deteriorated may be selectively generated by generating different image data with a single camera module and by selectively positioning a dummy pattern on the camera. The detailed description will be provided below.

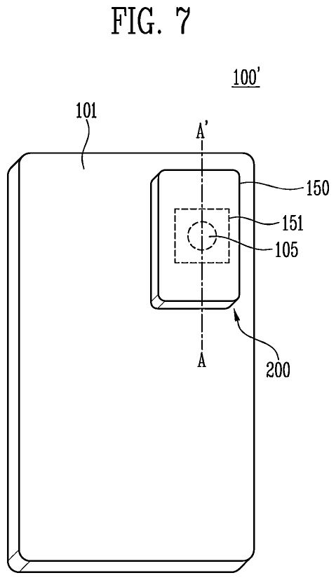

FIG. 7 is a schematic diagram illustrating another embodiment of the image data obtainment device 100′ for training of the image restoration module.

Referring to FIG. 7, the image data obtainment device 100′ may include a housing 101, a camera module 105, and a pattern mount unit 200. For example, the pattern mount unit 200 may include a dummy pattern 151 and a body 150.

The housing 101 and the camera module 105 may be included in a mobile device which is commercially available. For example, the camera module 105 may be formed as the general camera other than the under-display camera. For example, the housing 101 may be a housing of a general mobile phone or tablet PC. For example, the camera module 105 may be a camera provided (embedded) on a rear surface of the mobile phone other than a front surface where the display panel is formed. For example, the image data obtainment device 100′ may include a mobile device.

However, this is an example, and the housing 101 and the camera module 105 may not be included in the mobile device. The housing 101 may include only the camera module 105 and circuits related thereto. For example, the image data obtainment device 100′ according to an embodiment may be implemented as only the camera module 105 without a mobile device.

The body 150 of the pattern mount unit 200 may be fixed to the housing 101. For example, the body 150 may be mechanically coupled to the dummy pattern 151. According to an embodiment, a position of the dummy pattern 151 may not be fixed, and the dummy pattern 151 may be coupled to the body 150 so as to be in at least two different positions. For example, the dummy pattern 151 may include a pattern equal or similar to the display pattern formed on the under-display camera. However, the pattern formed on the dummy pattern 151 may not form the display panel.

The image data obtainment device 100′ shown in FIG. 7 may include the pattern mount unit 200 capable of selectively positioning the dummy pattern 151 on the camera module 105. Accordingly, a single camera module 105 may generate both the image data deteriorated by the dummy pattern and the image data having good quality which is not deteriorated without changing a position and a view angle. Accordingly, a result of restoration training for image restoration may be improved, and as a result, quality of restoration image data generated by the image restoration module may also be improved.

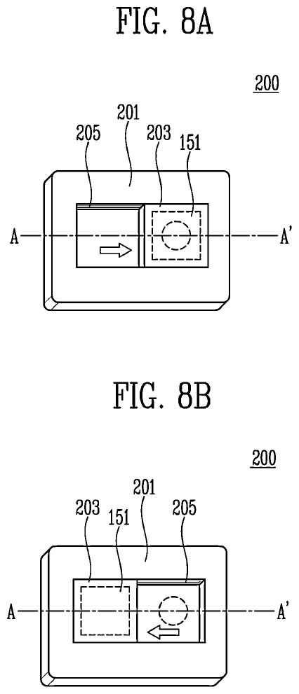

FIGS. 8A and 8B are schematic diagrams illustrating an embodiment of the pattern mount unit 200 included in the image data obtainment device 100′. Referring to FIGS. 8A and 8B together, the pattern mount unit 200 may include a body 201 and a dummy pattern forming unit 203. A dummy pattern 151 equal or similar to the display pattern may be formed in the dummy pattern forming unit 203. For example, the body 201 may be formed using a guide 205 for moving the dummy pattern forming unit 203. The guide 205 may be a groove formed in a straight line in a rail shape on an inner surface of a cavity formed in a rectangular shape in the body 201. For example, a protrusion may be formed on a side surface of the dummy pattern forming unit 203 and may be engaged with the groove shape of guide 205.

For example, the guide 205 may be a protrusion formed in a straight line in a rail shape on the inner surface of the rectangular shape of cavity formed in the body 201. For example, a groove may be formed on a side surface of the dummy pattern forming unit 203, and thus may be engaged with the protrusion shape of guide 205. In either case, the dummy pattern forming unit 203 may move left and right along a rail. For example, the dummy pattern forming unit 203 may have a shape of a sliding door. FIG. 8A shows the pattern mount unit 200 of a case where the dummy pattern forming unit 203 is moved to the right so that the dummy pattern 151 is at a first position. For example, FIG. 8B shows the pattern mount unit 200 of a case where the dummy pattern forming unit 203 is moved to the left so that the dummy pattern 151 is at a second position.

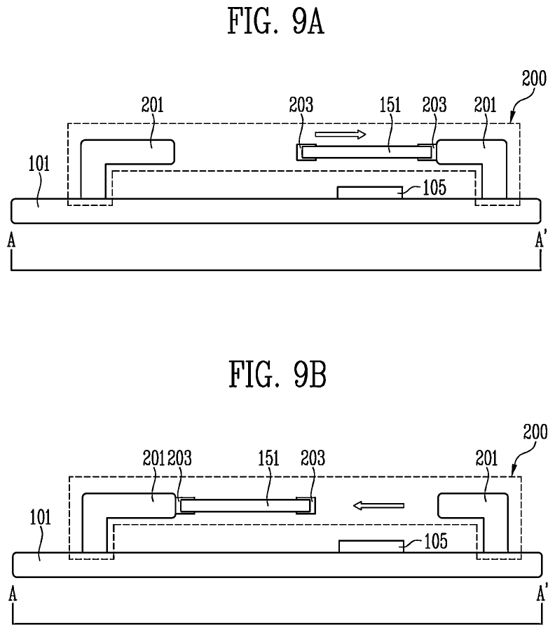

FIGS. 9A and 9B are cross-sectional views of the pattern mount unit 200 shown in FIGS. 8A and 8B, respectively. FIG. 9A is a cross-sectional view of the image data obtainment device 100′ taken along line A-A′ of FIG. 8A in case that the dummy pattern 151 is at the first position. FIG. 9B is a cross-sectional view of the image data obtainment device 100′ taken along line A-A′ of FIG. 9B in case that the dummy pattern 151 is at the second position.

Referring to FIGS. 8A and 9A, in case that the dummy pattern 151 is at the first position, the dummy pattern 151 may be positioned on the camera module 105. Therefore, light may pass through a pattern formed in the dummy pattern 151 and enter the camera module 105. Image data generated by capturing of the camera module 105, while the dummy pattern 151 is at the first position, may correspond to the deteriorated image data generated by the camera module 105, which is formed as the under-display camera.

Referring to FIGS. 8B and 8B, in case that the dummy pattern 151 is at the second position, light may enter the camera module 105 without passing through the pattern formed in the dummy pattern 151. Image data generated by capturing of the camera module 105, while the dummy pattern 151 is at the second position, may correspond to the image data having good quality generated by the camera module 105, which is formed as the general camera other than the under-display camera.

In an embodiment, a human may directly (or physically) adjust a position of the dummy pattern forming unit 203 by hand. In another embodiment, the pattern mount unit 200 may electrically adjust the position of the dummy pattern forming unit 203 with an electrically controllable means such as an actuator.

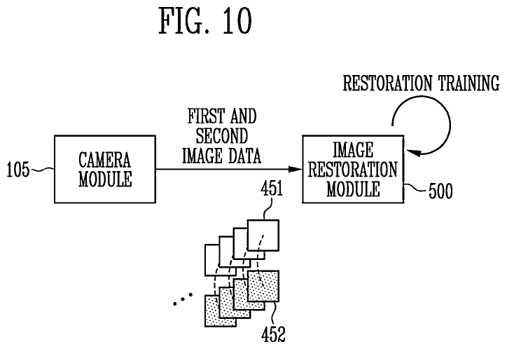

FIG. 10 is a schematic block diagram illustrating a system for training the image restoration module 500 using the image data obtainment device 100′ shown in FIGS. 7 to 9B.

Referring to FIG. 10, the camera module 105 included in the image data obtainment device 100′ may obtain both of first image data 451 and second image data 452 and transmit both of the first image data 451 and the second image data 452 to an image restoration module 500 as the image data pair. The image restoration module 500 may perform restoration training based on the received first and second image data 451 and 452. As described above, the image restoration module 500 may perform restoration training through deep learning using a plurality of image data pairs. As described with reference to FIGS. 7 to 9B, in case of using the image data obtainment device 100′, both of the deteriorated image data and the image data having good quality which is not deteriorated may be generated using a single camera module 105. For example, by manipulating the pattern mount unit 200 included in the image data obtainment device 100′, the dummy pattern 151 may be positioned at the first position on the camera module 105 or at the second position other than an upper portion of the camera module 105. Accordingly, a single camera module 105 may generate both of the image data deteriorated by the dummy pattern and the image data having good quality which is not deteriorated without changing the position or the view angle. Accordingly, a result of restoration training for image restoration may be improved, and as a result, quality of restoration image data generated by the image restoration module 500 may also be improved.

However, even though the image data obtainment device 100′ shown in FIGS. 7 to 9B is used, a position or a field of view of the camera module 105 may change somewhat according to a position change of the dummy pattern 151.

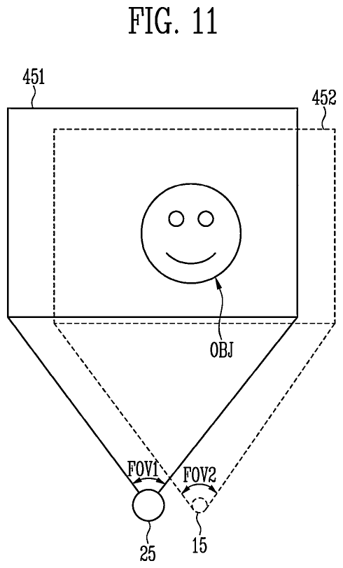

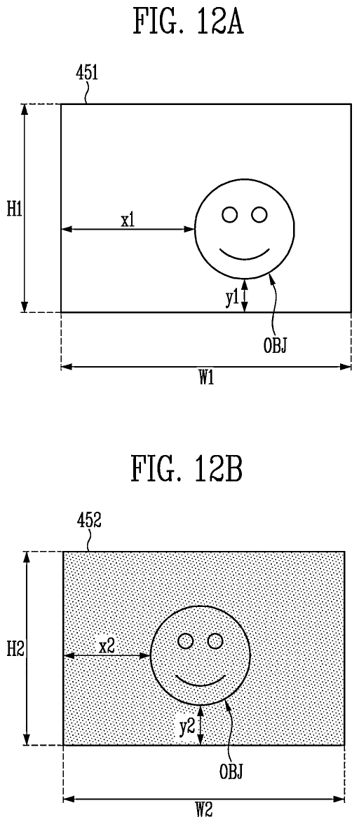

FIG. 11 is a schematic diagram illustrating a difference between the first and second image data 451 and 452 obtained by the image obtainment device of FIG. 4. FIG. 12A is a schematic diagram illustrating first image data generated by a first camera module 25 of FIG. 11. FIG. 12B is a schematic diagram illustrating second image data generated by a second camera module 15 of FIG. 11. Hereinafter, the disclosure is described with reference to FIGS. 11, 12A, and 12B together.

Referring to FIG. 11, capture areas of first and second image data 451 and 452 generated in case that the first and second camera modules 25 and 15 capture the object OBJ are shown. The first and second camera modules 25 and 15 shown in FIG. 4 may be camera modules having different specifications, respectively. For example, view angles or resolutions of the first and second camera modules 25 and 15 may be different from each other. For example, since each of the first and second camera modules 25 and 15 does not capture the object OBJ at the same position, a parallax may exist between the first and second camera modules 25 and 15. For example, the field of view FOV1 of the first camera module 25 and the field of view FOV2 of the second camera module 15 may be different from each other. Accordingly, the capture area of the first image data 451 generated by the first camera module 25 and the capture area of the second image data 452 generated by the second camera module 15 may become different from each other.

As shown in FIG. 12A, the image data generated by the first camera module 25 may include image data for the capture area of the first image data 451. Each capture area of the first and second image data 451 and 452 may have a width W1 and a height H1. For example, in the capture area of the first image data 451, the object OBJ may have a horizontal position x1 and a vertical position y1.

For example, as shown in FIG. 12B, the image data generated by the second camera module 15 may include image data for the capture area of the second image data 452. Each capture area of the first and second image data 451 and 452 may have a width W2 and a height H2. For example, in the capture area of the second image data 452, the object OBJ may have a horizontal position x2 and a vertical position y2. Since the second camera module 15 is formed as the under-display camera, the image data generated by the second camera module 15 may be shaded.

As described above, since the view angles of the first and second camera modules 25 and 15 are different, the width W1 and the height H1 of the capture area of the first image data 451 of the image data generated by the first camera module 25 may be different from the width W2 and the height H2 of the capture area of the second image data 452 of the image data generated by the second camera module 15, respectively. For example, since the view angles and the positions of the first and second camera modules 25 and 15 are different, the horizontal and vertical positions x1 and y1 of the object OBJ in the capture area of the first image data 451 of the image data generated by the first camera module 25 may be different from the horizontal and vertical positions x2 and y2 of the object OBJ in the capture area of the second image data 452 of the image data generated by the second camera module 15.

For example, in case that the first and second image data 451 and 452 are obtained by the image obtainment device of FIG. 7, since the same camera module is used, a size and resolution of the first and second image data 451 and 452 may be the same as each other. However, for example, the position or the field of view of the camera module 105 may change somewhat due to vibration generation caused by an operation of changing the position of the dummy pattern 151.

In image restoration training using the deep learning algorithm, as the position and the size of the object OBJ in the first image data is similar to the position and the size of the object OBJ in the second image data, a result of restoration training may be better or improved. For example, the most desirable training result may be derived in case that the size and the position of the object OBJ are the same in the first and second image data 451 and 452, and an image restoration operation may also be successfully performed.

However, in case that the first and second image data 451 and 452 captured as shown in FIGS. 12A and 12B are used for restoration training, since the capture area of each image data 451 and 452 is different and the position of the object OBJ in each capture area of the first and second image data 451 and 452 is different, a result of restoration training may be inadequate. Therefore, the size and the position of the object OBJ may be required to match in the first and second image data 451 and 452. However, as described above, in case that the specifications of the first and second camera modules are different, since the size of the capture area is different, even though the image data is resized to the same resolution, the size of the object OBJ in the capture area of each image data may be different.

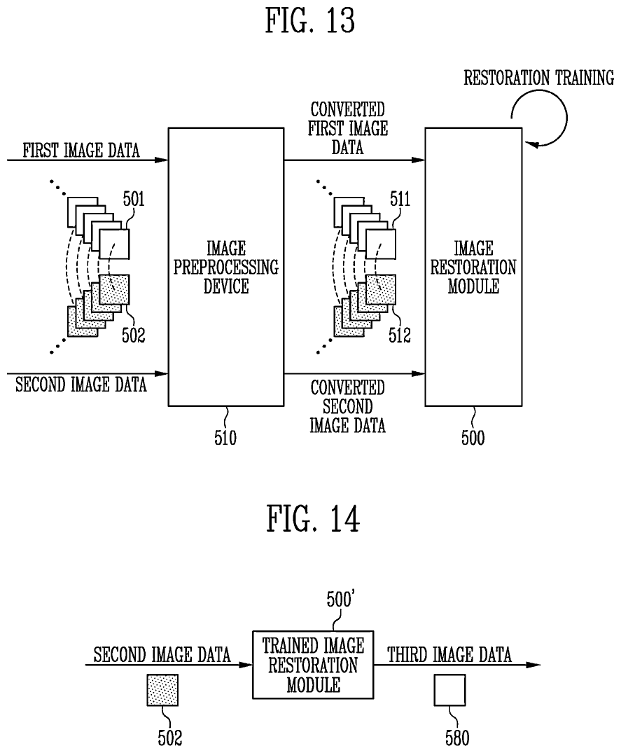

FIG. 13 is a schematic block diagram illustrating an operation of an image preprocessing device 510 according to an embodiment.

Referring to FIG. 13, the image preprocessing device 510 may receive first and second image data 501 and 502. As described above, the first and second image data 501 and 502 may be an image data pair provided for restoration training of the image restoration module 500.

The image preprocessing device 510 may convert the first and second image data 501 and 502. For example, the image preprocessing device 510 may output converted first and second image data 511 and 512 to the image restoration module 500.

For example, the image preprocessing device 510 according to an embodiment may generate reference image data from the first image data 501 and may generate a plurality of crop image data based on the second image data 502. The image preprocessing device 510 may compare each of the plurality of crop image data with the reference image data and may select crop image data based on the smallest loss function value. For example, the image preprocessing device 510 may transmit the reference image data to the image restoration module 500 as the converted first image data 511, and may transmit the selected crop image data to the image restoration module 500 as the converted second image data 512.

According to an image preprocessing device 510 and an image preprocessing method according to an embodiment, the converted first and second image data 511 and 512 may be generated based on the first and second image data 501 and 502. For example, according to an image preprocessing device 510 and an image preprocessing method according to an embodiment, the reference image data may be generated from the first image data, and the plurality of crop image data may be generated based on the second image data. For example, each of the plurality of crop image data may be compared with the reference image data, and the crop image data may be selected based on the smallest loss function value. For example, the reference image data may be transmitted to the image restoration module 500 as the converted first image data 511 and the selected crop image data is transmitted to the image restoration module 500 as the converted second image data 512.

FIG. 14 is a schematic block diagram illustrating a method of recovering the deteriorated image data using the image restoration module 500′ trained through restoration training of FIG. 13.

Referring to FIG. 14, the second image data 502 may be transmitted to a trained image restoration module 500′. The second image data 502 may be image data captured by the under-display camera. The image restoration module 500′ may be in a trained state using a large amount of image data pairs including the first and second image data 501 and 502 converted by the image preprocessing device 510 as described with reference to FIG. 13. The image restoration module 500′ may recover the received second image data 502 and generate third image data 580.

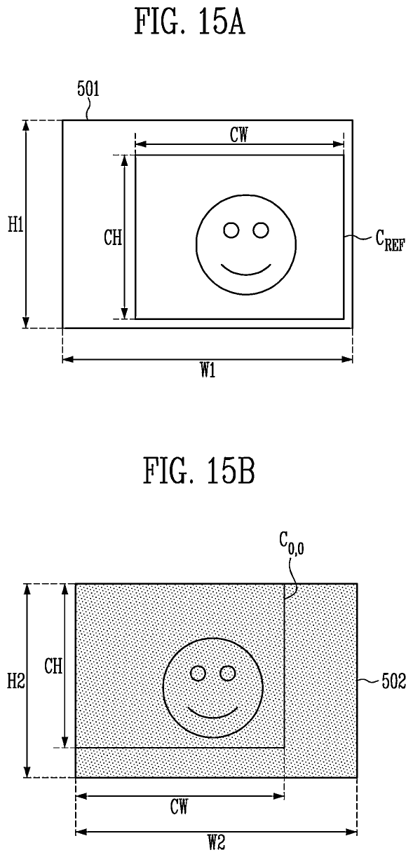

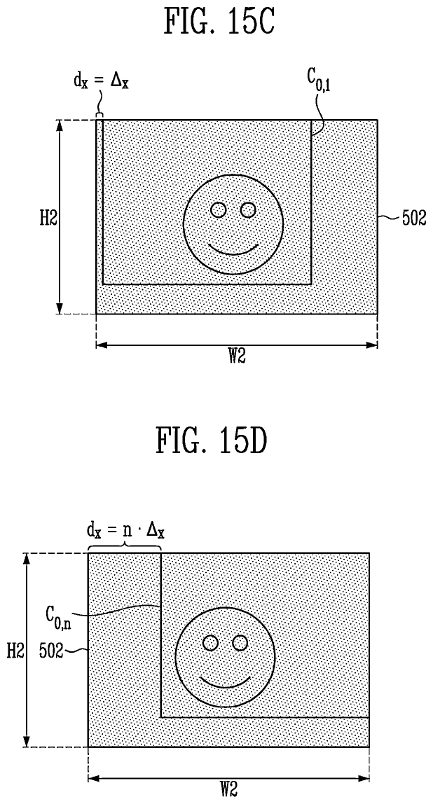

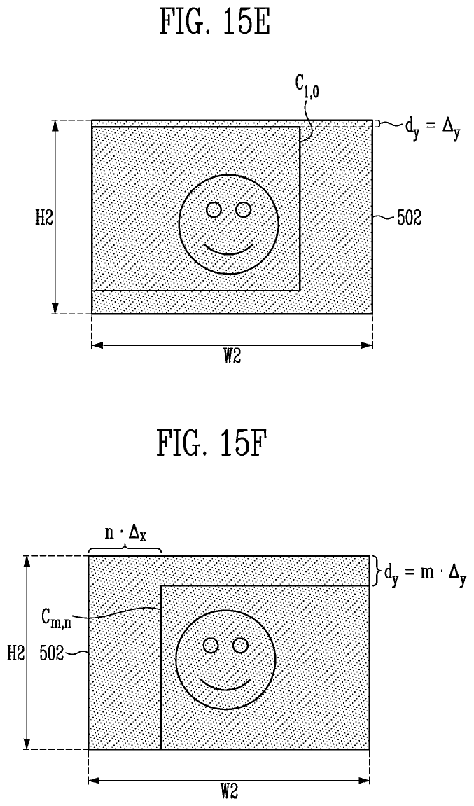

FIGS. 15A to 15F are schematic diagrams illustrating an operation of an image preprocessing device 510 according to an embodiment.

Referring to FIG. 15A, reference image data C_{REF} may be generated based on the first image data 501. The image preprocessing device 510 may generate the reference image data C_{REF} by cropping a partial area of the received first image data 501. For example, the reference image data C_{REF} may be generated by cropping an area having a width CW and a height CH in the first image data 501 having the width W1 and the height H1 as shown in FIG. 15A. A size and a position of the reference image data C_{REF} in the first image data 501 may be variously determined.

Referring to FIGS. 15B to 15F, a plurality of crop image data generated based on the second image data 502 are shown. In an embodiment, a size of each of the plurality of crop image data may be the same as the size of the reference image data C_{REF} shown in FIG. 15A. For example, each of the plurality of crop image data may have the width CW and the height CH.

Referring to FIG. 15B, crop image data C_{0,0} among the plurality of crop image data is shown. The crop image data C_{0,0} may be positioned at the uppermost and the leftmost area of the second image data 502 and may include an area having the width CW and the height CH.

Referring to FIG. 15C, crop image data C_{0,1} among the plurality of crop image data is shown. The crop image data C_{0,1} may include an area moved to the right by a horizontal movement value dₓ based on the crop image data Coo. For example, the horizontal movement value dₓ may have the same value as a unit length Δₓ.

In an embodiment, a value of the unit length Δₓ may be a value corresponding to a single pixel width. In another embodiment, the value of the unit length Δₓ may be a value corresponding to an integer multiple of a pixel width. As the value of the unit length Δₓ is decreased, the number of crop image data generated from the second image data 502 may be increased, and an image preprocessing operation may be performed more accurately. For example, as the value of the unit length Δₓ is increased, the number of crop image data generated from the second image data 502 may be decreased. Thus, a calculation amount may be reduced, and quality of the image preprocessing operation may be reduced.

After generation of the crop image data C_{0,1}, crop image data C_{0,2} may be generated. For example, the crop image data C_{0,2} may include an area moved by the horizontal movement value dₓ to the right based on the crop image data C_{0,0}, and this may correspond to an area moved by the unit length Δₓ to the right from the crop image data C_{0,1}. The horizontal movement value dₓ may be a value corresponding to twice the unit length Δₓ.

In such a method described above, a plurality of crop images may be generated from the second image data 502 while moving by the unit length Δₓ in a row direction. Referring to FIG. 15D, crop image data C_{0,n} including an area moved to the right by a maximum horizontal movement value dₓ based on the crop image data C_{0,0} is shown. For example, the horizontal movement value dₓ may have a value corresponding to n times the unit length Δₓ. The crop image data C_{0,0} to C_{0,1} may be crop image data corresponding to a first row among the plurality of crop image data generated from the second image data 502.

Referring to FIG. 15E, crop image data C_{1,0} among the plurality of crop image data is shown. The crop image data C_{1,0} may include an area moved in a lower direction by a vertical movement value d_{y} based on the crop image data C_{0,0}. For example, the vertical movement value d_{y} may have the same value as a unit length Δ_{y}.

In an embodiment, a value of the unit length Δ_{y} may be a value corresponding to a single pixel width. In another embodiment, the value of the unit length Δ_{y} may be a value corresponding to an integer multiple of the pixel width. According to an embodiment, the value of the unit length Δ_{y} may be the same as the value of the unit length Δₓ. In another embodiment, the value of the unit length Δ_{y} may be different from the value of the unit length Δₓ.

The crop image data C_{1,0} may be included in crop image data corresponding to a second row among the plurality of crop image data generated from the second image data 502. For example, the crop image data C_{1,0} may be crop image data corresponding to the leftmost area of the second image data 502 among the crop image data corresponding to the second row. Similarly to that described above with reference to FIGS. 15B to 15D, crop image data C_{1,0} to C_{1,n} corresponding to the second row may be generated.

In the method described above, crop image data corresponding to third to last rows may be sequentially generated. Referring to FIG. 15F, crop image data C_{m,n} corresponding to the rightmost area of the second image data 502 among the crop image data corresponding to the last row is shown. The crop image data C_{m,n} may include an area moved to the right by the horizontal movement value dₓ and moved to downwardly by the vertical movement value d_{y} based on the crop image data C_{0,0}. For example, the horizontal movement value dₓ may have a value corresponding to n times the unit length Δₓ, and the vertical movement value d_{y} may have a value corresponding to m times the unit length Δₓ. Through such a process, (m+1)·(n+1) pieces of crop image data may be generated.

Throughout this specification, an embodiment in which the reference image data C_{REF} may be generated based on the first image data 501, which is the image data having good quality which is not deteriorated and the plurality of crop image data are generated based on the second image data 502 which is the deteriorated image data is described. However, embodiments are not limited thereto, and the reference image data C_{REF} may be generated based on the second image data 502 which is the deteriorated image data and the plurality of crop image data may be generated based on the first image data 501, which is the image data having good quality which is not deteriorated.

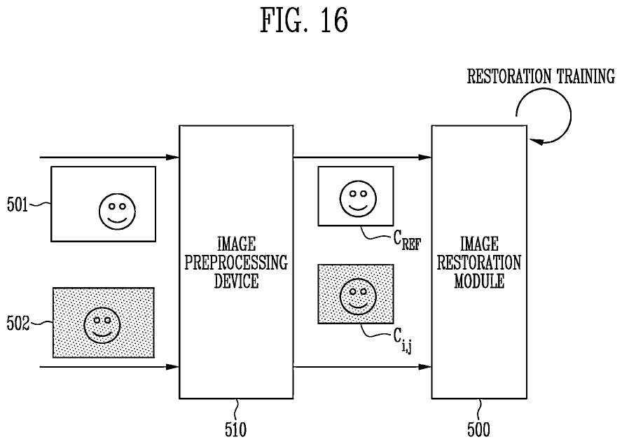

FIG. 16 is a schematic diagram illustrating an operation of an image preprocessing device 510 according to an embodiment.

Referring to FIG. 16, the image preprocessing device 510 may receive the first and second image data 501 and 502. As described above, the first and second image data 501 and 502 may be the image data pair provided for restoration training of the image restoration module 500.

The image preprocessing device 510 may generate converted first image data 511 based on the first image data 501. As described above with reference to FIG. 15A, the converted first image data 511 may be the reference image data C_{REF}. For example, the image preprocessing device 510 may generate converted second image data 512 based on the first and second image data 501 and 502. For example, the image preprocessing device 510 may select one of the plurality of crop image data C_{0,0} to C_{m,n} described above with reference to FIGS. 15B to 15F, and may transmit the selected crop image data C_{i,j} to the image restoration module 500 as the converted second image data 512.

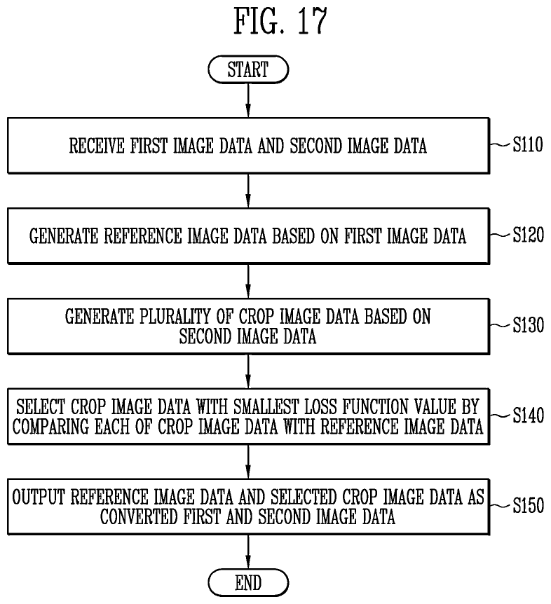

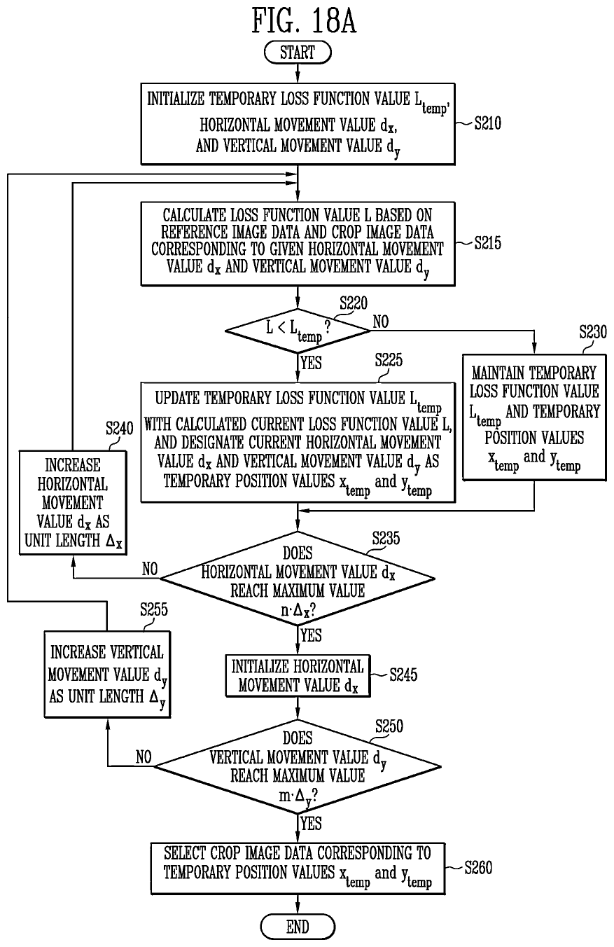

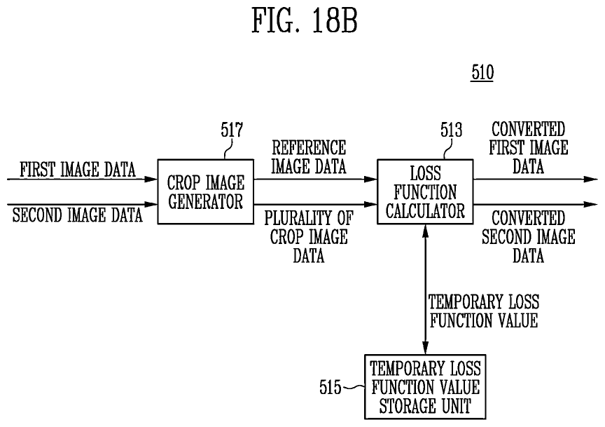

According to an embodiment, an operation of selecting one of the plurality of crop image data C_{0,0} to C_{m,n} by the image preprocessing device 510 is described layer with reference to FIGS. 17, 18A, and 18B.

FIG. 17 is a flowchart illustrating a method of operating an image preprocessing device 510 according to an embodiment.

Referring to FIG. 17, the method of operating the image preprocessing device 510 may include receiving first image data 501 and second image data 502 (S110), generating reference image data C_{REF} based on the first image data 501 (S120), generating a plurality of crop image data based on the second image data (S130), comparing each crop image data with the reference image data C_{REF} and selecting crop image data based on the smallest loss function value (S140), and outputting the reference image data C_{REF} and the selected crop image data as converted first and second image data 511 and 512 (S150).

In the step S110, the image preprocessing device 510 may receive the first image data 501 and the second image data 502. As described above, the first image data 501 may be image data of image quality which is not deteriorated, and the second image data 502 may be image data having image quality which is deteriorated by the display pattern or the dummy pattern. The first and second image data 501 and 502 may be image data generated by different camera modules or may be image data generated by the same camera module.

In the step S120, the reference image data C_{REF} may be generated by cropping the first image data 501. As described above with reference to FIG. 15A, the image preprocessing device 510 may generate the reference image data C_{REF} by cropping a partial area of the received first image data 501.

In the step S130, the plurality of crop image data may be generated by cropping the second image data 502 at a plurality of positions. A size of the plurality of crop image data generated in the step S130 may be the same as a size of the reference image data C_{REF} generated in the step S120. For example, as described with reference to FIGS. 15B to 15F, the plurality of crop image data may be generated by cropping areas having a distance of the unit lengths Ax and Ay in an area of the second image data 502.

In the step S140, the reference image data C_{REF} generated in the step S120 may be compared with each of the plurality of crop image data generated in the step S130. For example, a value of a loss function may be calculated based on the reference image data C_{REF} and the individual crop image data, and crop image data may be selected based on the smallest calculated loss function value.

The loss function may be a function for calculating the smallest difference value between two images. In an embodiment, a loss function L1 may be calculated based on a mean squared error (MSE) in a spatial domain of two image data as shown in Equation 1 below.

$$L 1 ( D 1 , D 2 ) = {\sum }_{x = 1}^{N} {\sum }_{y = 1}^{M} {( D 1 ( x , y ) - D 2 ( x , y ) )}^{2} \qquad [ Equation 1 ]$$

Here, D1 and D2 may indicate image data, and D1(x,y) and D2(x,y) may indicate data values of a pixel position (x,y) in D1 and D2, respectively. As a position difference of the object OBJ between the two image data is decreased, the value of the loss function according to Equation 1 may be decreased.

As another embodiment, a loss function L2 may be calculated based on an absolute value in a frequency domain of the two image data as shown in Equation 2 below.

$$L 2 ( D 1 , D 2 ) = {\sum }_{u = 1}^{N} {\sum }_{v = 1}^{M} \vert {F}_{D 1} ( u , v ) - {F}_{D 2} ( u , v ) \vert \qquad [ Equation 2 ]$$

Here, D1 and D2 may indicate image data, F_{D1}(u,v) may indicate Fourier transform of the image data D1, and F_{D2}(u,v) may indicate Fourier transform of the image data D2. A loss function L2 value may be calculated by summing an absolute value of an amplitude difference of data values corresponding to an x-axis direction frequency u and a y-axis direction frequency v in the frequency domain. As the position difference of the object OBJ of the two image data is decreased, a value of the loss function according to Equation 2 may be decreased.

As another embodiment, a loss function L3 may be calculated based on the absolute value in the frequency domain of the two image data as shown in Equation 3 below.

$$L 3 ( D 1 , D 2 ) = {\sum }_{u = 1}^{N} {\sum }_{v = 1}^{M} \vert ∠ {F}_{D 1} ( u , v ) - ∠ {F}_{D 2} ( u , v ) \vert \qquad [ Equation 3 ]$$

Here, D1 and D2 may indicate image data, F_{D1}(u,v) may indicate the Fourier transform of the image data D1, and F_{D2}(u,v) may indicate the Fourier transform of the image data D2. A loss function L3 value may be calculated by summing absolute values of a phase difference of the data values corresponding to the x-axis direction frequency u and the y-axis direction frequency v in the frequency domain. As the position difference of the object OBJ of the two image data is decreased, the value of the loss function according to Equation 3 may be decreased.

As still another embodiment, all of the loss functions described through Equations 1 to 3 may be used. For example, a loss function L4 may be calculated as shown in Equation 4 below.

$$L 4 ( D 1 , D 2 ) = {λ}_{1} \cdot L 1 ( D 1 , D 2 ) + {λ}_{2} \cdot L 2 ( D 1 , D 2 ) + {λ}_{3} \cdot L 3 ( D 1 , D 2 ) \qquad [ Equation 4 ]$$

Here, L1(D1,D2) may be the loss function described through Equation 1, L2(D1,D2) may be the loss function described through Equation 2, and L3(D1,D2) may be the loss function described through Equation 3. The coefficients λ1, λ2, and λ3 for each factor may be determined as arbitrary real numbers. As an embodiment, at least one of the coefficients λ₁, λ₂, and λ₃ may be 0. As another embodiment, two of the coefficients λ₁, λ₂, and λ₃ may be 0.

In the step S140, the loss function may be calculated based on one of the reference image data C_{REF} and the crop image data C_{0,0} to C_{0,1}. The calculated loss function value may be (m+1)·(n+1), which is the number of crop image data. The image preprocessing device 510 may select crop image data corresponding to the smallest loss function value among (m+1)·(n+1) loss function values. Referring to FIG. 16 together, among the loss function values calculated corresponding to each of the reference image data C_{REF} and the crop image data C_{0,0} to C_{0,1}, in case that the loss function value calculated based on the reference image data C_{REF} and the crop image data C_{i,j} is the smallest, the image preprocessing device 510 may select the crop image data C_{i,j}.

A more detailed embodiment of the step S140 is described with reference to FIG. 18A.

In the step S150, the image preprocessing device 510 may output the reference image data C_{REF} generated in the step S120 as the converted first image data 511, and may output the crop image data C_{i,j} selected in the step S140 as the converted second image data 512. The output first and second image data 501 and 502 may be transmitted to the image restoration module 500 and used for restoration training of the image restoration module 500.

FIG. 18A is a flowchart illustrating an embodiment of the step S140 of FIG. 17.

Referring to FIG. 18A, in the step S210, a temporary loss function value Lₜₑₘₚ, the horizontal movement value dₓ, and the vertical movement value d_{y} may be initialized. The temporary loss function value Lₜₑₘₚ may be a variable for finding the smallest loss function value among each loss function value. In the step S210, the temporary loss function value Lₜₑₘₚ may be initialized to a relatively large value. For example, the horizontal movement value dₓ and the vertical movement value d_{y} may correspond to the horizontal movement value dₓ and the vertical movement value d_{y} of the crop image data described with reference to FIGS. 15B to 15F. In the step S210, the horizontal movement value dₓ and the vertical movement value d_{y} may be initialized to 0. Accordingly, initial crop image data may become the crop image data C_{0,0} shown in FIG. 15B.

In the step S215, the loss function may be calculated based on the crop image data corresponding to the given horizontal movement value dₓ and vertical movement value d_{y} and the reference image data C_{REF} generated in the step S120 of FIG. 17. For example, the value of the loss function may be calculated based on the crop image data C_{0,0} and the reference image data C_{REF} shown in FIG. 15B. The loss function value of the step S215 may be calculated using one of Equations 1 to 4.

In the step S220, the calculated loss function value L and the temporary loss function value Lₜₑₘₚ may be compared. Since the temporary loss function value Lₜₑₘₚ initialized in the step S210 is a relatively large value, in the step S220, it may be determined that the calculated loss function value L is less than the temporary loss function value Lₜₑₘₚ.

In case that the calculated loss function value L is less than the temporary loss function value Lₜₑₘₚ (S220: Yes), the temporary loss function value Lₜₑₘₚ may be updated with the loss function value L calculated in the step S215. In case that the calculated loss function value L is less than the temporary loss function value Lₜₑₘₚ, the current horizontal movement value dₓ and vertical movement value d_{y} may be designated as temporary position values xₜₑₘₚ and yₜₑₘₚ. The temporary position values xₜₑₘₚ and yₜₑₘₚ may be a variable for temporarily maintaining the horizontal movement value dₓ and the vertical movement value d_{y} corresponding to the currently updated temporary loss function value Lₜₑₘₚ.

In case that the calculated loss function value L is greater than or equal to the temporary loss function value Lₜₑₘₚ (S220: No), the temporary loss function value Lₜₑₘₚ may not be updated. Since this means that the loss function value L calculated in the step S215 is not a minimum loss function value, the loss function value L calculated in the step S215 may be discarded. For example, the temporary loss function value Lₜₑₘₚ and temporary position values θₜₑₘₚ, xₜₑₘₚ, and yₜₑₘₚ corresponding thereto may be maintained.

Thereafter, in the step S235, it may be determined whether the horizontal movement value dₓ reaches a maximum value “n·Δₓ”. In a case where the horizontal movement value dₓ does not reach the maximum value “n·Δₓ” in a state in which the vertical movement value d_{y} is 0 (S235: No), this means that a process of calculating the loss function value L based on each of crop image data corresponding to the first row C_{0,0} to C_{0,1} and the reference image data C_{REF} and comparing the loss function value L with the temporary loss function value Lₜₑₘₚ is not yet completed. For example, in order to calculate the loss function L for crop image data corresponding to a next row of a current row and the reference image data C_{REF} and to compare the loss function L with the temporary loss function value Lₜₑₘₚ, the horizontal movement value dₓ may be required to be increased by the unit length Δₓ. Therefore, in case that the horizontal movement value dₓ does not reach the maximum value “n·Δₓ” (S235: No), the method may proceed to the step S240.

In the step S240, the horizontal movement value dₓ may be increased by the unit length Δₓ, and the method may proceed to the step S215. Accordingly, calculating the loss function L based on the reference image data C_{REF} and the crop image data corresponding to the increased vertical movement value dₓ (S215), and comparing the calculated loss function L with the temporary loss function value Lₜₑₘₚ (S220) may be repeatedly performed. In case that the calculated loss function value L is less than the temporary loss function value Lₜₑₘₚ, the step S225 may be performed. In case that the calculated loss function value L is greater than or equal to the temporary loss function value Lₜₑₘₚ (S220: No), the temporary loss function value Lₜₑₘₚ may not be updated the step S230. The steps S215, S220, S225, S230, S235, and S240 may be repeatedly performed until an operation of calculating all loss function values L for the reference image data C_{REF} and the crop image data corresponding to one row and comparing each of the loss function value L with the temporary loss function value Lₜₑₘₚ may be completed. Steps S215, S220, S225, S230, S235, and S240 may configure a loop, and as the loop is repeated, the smallest value among the loss function values L calculated up to now may be updated with the temporary loss function value Lₜₑₘₚ. For example, as the loop is repeated, the horizontal movement value dₓ and the vertical movement value d_{y} corresponding to the smallest value among the loss function values L calculated up to now may be designated as the temporary position values xₜₑₘₚ and yₜₑₘₚ.

As a result of the determination of the step S235, in a case where the horizontal movement value dₓ reaches the maximum value “n·Δₓ” in a state in which the vertical movement value d_{y} is 0 (S235: Yes), this means that a process of calculating the loss function value L based on the reference image data C_{REF} and the crop image data C_{0,1} shown in FIG. 15D and comparing the loss function value L with the temporary loss function value Lₜₑₘₚ is completed. For example, in order to calculate the loss function L for each of the crop image data C_{1,0} to C_{1,n} for a next row and the reference image data C_{REF} and to compare the loss function L with the temporary loss function value Lₜₑₘₚ, the vertical movement value d_{y} may be required to be increased by the unit length Δ_{y}. Therefore, in case that the horizontal movement value dₓ reaches the maximum value “n·Δₓ” (S235: Yes), the method may proceed to the step S245.

In the step S245, the horizontal movement value dₓ may be initialized to 0. Thereafter, the method may proceed to the step S250 to determine whether a current vertical movement value d_{y} reaches a maximum value “m·Δ_{y}”. In a case where the vertical movement value d_{y} does not reach the maximum value “m·Δ_{y}” (S250: No), this means that a process of calculating the loss function value L based on each of all generated crop image data C_{0,0} to C_{m,n} and the reference image data C_{REF} and comparing the loss function value L with the temporary loss function value Lₜₑₘₚ is not yet completed. For example, in order to calculate the loss function L for crop image data corresponding to a first column of a next row and the reference image data C_{REF} and to compare the loss function L with the temporary loss function value Lₜₑₘₚ, the vertical movement value d_{y} may be required to be increased by the unit length Δ_{y}. Therefore, in case that the vertical movement value d_{y} does not reach the maximum value “m·Δ_{y}” (S250: No), the method may proceed to the step S255.

In the step S255, the vertical movement value d_{y} may be increased by the unit length Δₓ, and the method may proceed to the step S215. For example, the step S255 may correspond to an operation of changing a row for selecting crop image data that is a calculation object of the loss function value L. Accordingly, calculating the loss function L based on the reference image data C_{REF} and the crop image data corresponding to the increased vertical movement value d_{y} and the horizontal movement value dₓ initialized to 0 (S215), and comparing the calculated loss function L with the temporary loss function value Lₜₑₘₚ (S220) may be repeatedly performed.

Referring to the flowchart shown in FIG. 18A, the step S140 may include a small loop configured by a branch that returns to the step S215 in case that it is determined as “No” in the step S235, and a large loop configured by a branch that returns to the step 215 in case that it is determined as “No” in the step S250. As the small loop is repeatedly performed, an operation of searching for the minimum loss function value L may be performed while calculating the loss function value L based on the crop image data and the reference image data C_{REF} and comparing the loss function value L with the temporary loss function value Lₜₑₘₚ as a column number increases in one row. For example, as the large loop is repeatedly performed, an operation of searching for the minimum loss function value L may be performed while calculating the loss function value L based on the crop image data and the reference image data C_{REF} and comparing the loss function value L with the temporary loss function value Lₜₑₘₚ while increasing a row number.

As a result of the determination of the step S250, in a case where the vertical movement value d_{y} reaches the maximum value “m·Δ_{y}” (S250: Yes), this means that a process of calculating the loss function value L based on each of all crop image data C_{0,0} to C_{m,n} and the reference image data C_{REF} and comparing the loss function value L with the temporary loss function value Lₜₑₘₚ is completed. For example, the smallest value among all calculated loss function values L may be designated as the temporary loss function value Lₜₑₘₚ, and the horizontal movement value dₓ and the vertical movement value d_{y} corresponding to the smallest value among all calculated loss function values L may be designated as the temporary position values xₜₑₘₚ and yₜₑₘₚ. Therefore, crop image data corresponding to the temporary position values xₜₑₘₚ and yₜₑₘₚ may be selected (S260).

FIG. 18B is a schematic block diagram illustrating an embodiment of an image preprocessing device 510 according to an embodiment. Referring to FIG. 18B, the image preprocessing device 510 may include a crop image generator 517, a loss function calculator 513, and a temporary loss function value storage unit 515.

The crop image generator 517 may receive the first image data 501 and the second image data 502. For example, the crop image generator 517 may generate the reference image data C_{REF} based on the first image data 501. The generated reference image data C_{REF} may be transmitted to the loss function calculator 513. For example, the crop image generator 517 may generate the plurality of crop image data based on the second image data 502. The generated plurality of crop image data may be transmitted to the loss function calculator 513. Referring to FIG. 17 together, the steps S110, S120, and S130 may be performed by the crop image generator 517.

The loss function calculator 513 may calculate the loss function value based on one of the plurality of received crop image data and the reference image data C_{REF}. The loss function calculator 513 may calculate the loss function value using one of Equations 1 to 4.

The temporary loss function value storage unit 515 may store the temporary loss function value Lₜₑₘₚ described with reference to FIG. 18A. For example, the temporary loss function value storage unit 515 may also store the temporary position values xₜₑₘₚ and yₜₑₘₚ described with reference to FIG. 18A.

For example, the loss function calculator 513 may receive the temporary loss function value Lₜₑₘₚ from the temporary loss function value storage unit 515 in order to compare whether the calculated loss function value L is less than the temporary loss function value. In case that the calculated loss function value L is less than the temporary loss function value Lₜₑₘₚ, the loss function calculator 513 may update the temporary loss function value Lₜₑₘₚ with the calculated loss function value L and may provide the updated temporary loss function value Lₜₑₘₚ to the temporary loss function value storage unit 515. The temporary loss function value storage unit 515 may store the provided new temporary loss function value Lₜₑₘₚ.

For example, in case that the calculated loss function value L is less than the temporary loss function value Lₜₑₘₚ, the loss function calculator 513 may update the temporary position values xₜₑₘₚ and yₜₑₘₚ with the horizontal movement value dₓ and the vertical movement value d_{y} of the crop image data corresponding to the calculated loss function value L and may provide the updated temporary position values xₜₑₘₚ and yₜₑₘₚ to the temporary loss function value storage unit 515. The temporary loss function value storage unit 515 may store the provided new temporary position values xₜₑₘₚ and yₜₑₘₚ.

After calculating the loss function value L based on the crop image data and the reference image data C_{REF} for all crop image data and comparing the loss function value L with the temporary loss function value Lₜₑₘₚ, the loss function calculator 513 may output the reference image data C_{REF} as the converted first image data 511. For example, the loss function calculator 513 may output the crop image data corresponding to the final temporary position values xₜₑₘₚ and yₜₑₘₚ stored in the temporary loss function value storage unit 515 as the converted second image data 512. Referring to FIG. 17 together, the steps S140 and S150 may be performed by the loss function calculator 513.

The crop image generator 517 and the loss function calculator 513 shown in FIG. 18B may be implemented as individual microprocessors or an integrated microprocessor. For example, the microprocessor may be operated by software, firmware, or the like designed to perform an operation of the crop image generator 517 and the loss function calculator 513. For example, the temporary loss function value storage unit 515 may be implemented as an arbitrary electronic recording medium. For example, the temporary loss function value storage unit 515 may be implemented as a volatile/non-volatile memory device such as a random access memory (RAM) or a flash memory.

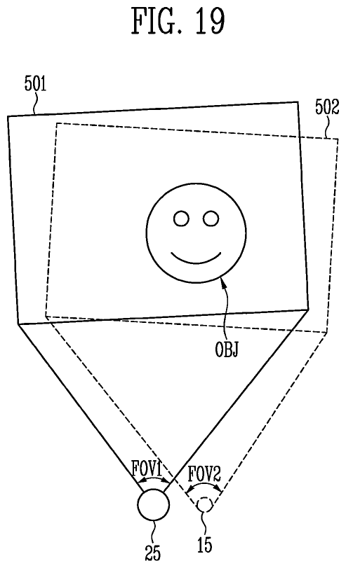

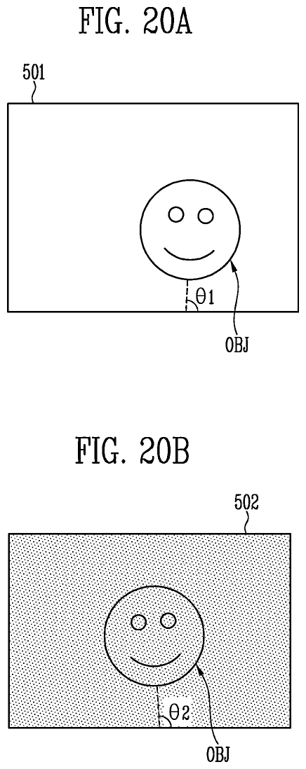

FIG. 19 is another schematic diagram illustrating the difference between the first and second image data 501 and 502 obtained by the image obtainment device of FIG. 4. FIG. 20A is a schematic diagram illustrating first image data 501 generated by a first camera module 25 of FIG. 19. FIG. 20B is a schematic diagram illustrating second image data 502 generated by a second camera module 15 of FIG. 19. Hereinafter, the embodiment is described with reference to FIGS. 19, 20A, and 20B.

Referring to FIG. 19, capture areas of first and second image data 501 and 502 generated in case that the first and second camera modules 25 and 15 capture the object OBJ are shown. Differently from FIG. 11, a rotation angle difference may occur between the capture area of the first image data 501 captured by the first camera module 25 and the capture area of the second image data 502 captured by the second camera module 15 in FIG. 19.

As shown in FIG. 20A, the image data generated by the first camera module 25 may include image data for the capture area of the first image data 501. Due to the rotation angle of the capture area of the first image data 501 that occurs in case that the first camera module 25 captures the object OBJ, an angle θ1 may exist between a line crossing an exact center of the object OBJ in the capture area of the first image data 501 and a horizontal line based on the capture area of the first image data 501. For example, as shown in FIG. 20B, the image data generated by the second camera module 15 may include image data for the capture area of the second image data 502. Due to the rotation angle of the capture area of the second image data 502 that occurs in case that the second camera module 15 captures the object OBJ, an angle θ2 may exist between the line crossing the exact center of the object OBJ in the capture area of the second image data 502 and a horizontal line based on the capture area of the second image data 502. In case that the angle θ1 and the angle θ2 are different from each other, the image preprocessor may not perform an optimal preprocessing operation using only the method described with reference to FIGS. 15A to 18B. In the above, a case where the image data captured by the first and second camera modules 25 and 15 have different rotation angles is described, but even in a case where the first and second image data 501 and 502 are obtained using the same camera module by the image obtainment device of FIG. 7, rotation may occur in an area captured by the camera module due to vibration caused by an operation of changing a position of the dummy pattern 151.

In accordance with an image preprocessor and a method of operating the image preprocessor according to another embodiment, crop image data may be generated based on second image data 502 rotated by applying a plurality of rotation angles to the second image data 502. Therefore, an optimal preprocessing operation may be performed even in a case where a rotation angle difference exists between the first image data 501 and the second image data 502.

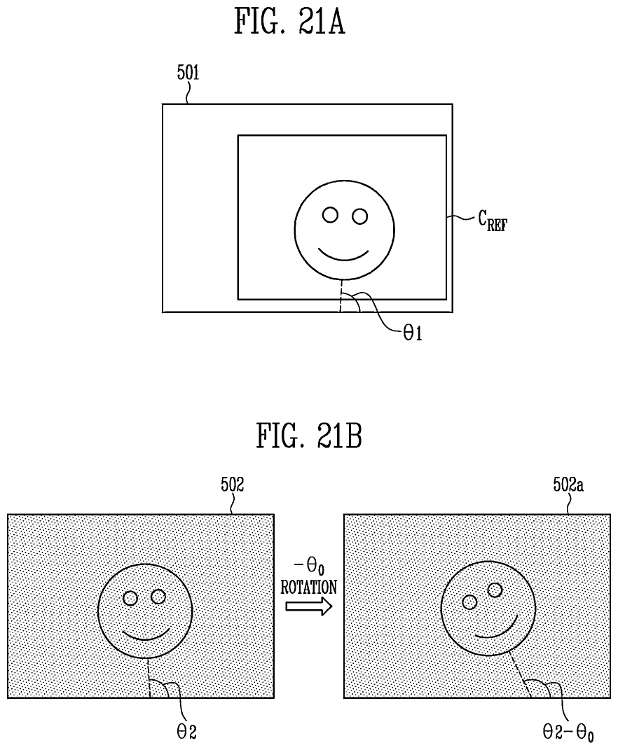

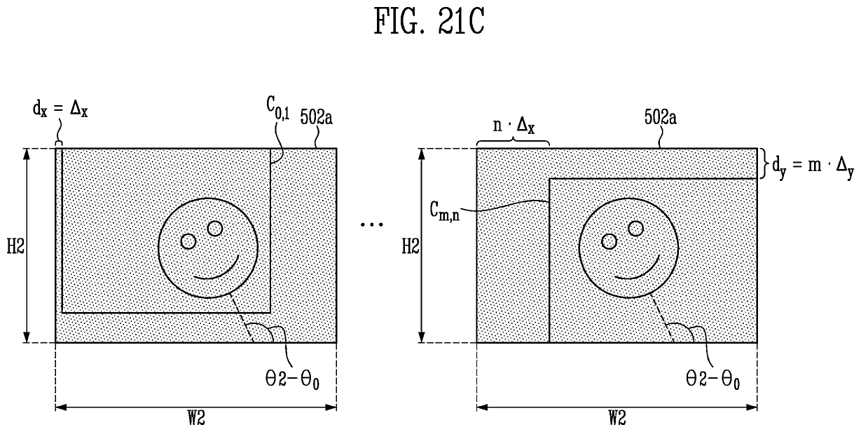

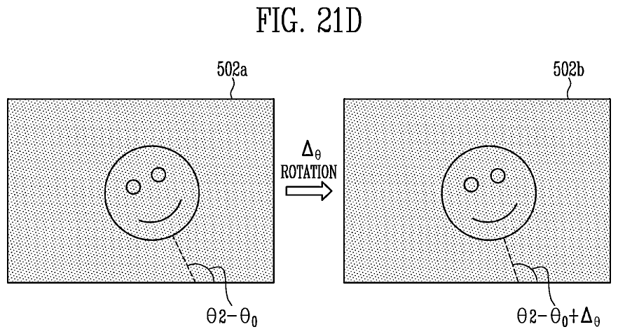

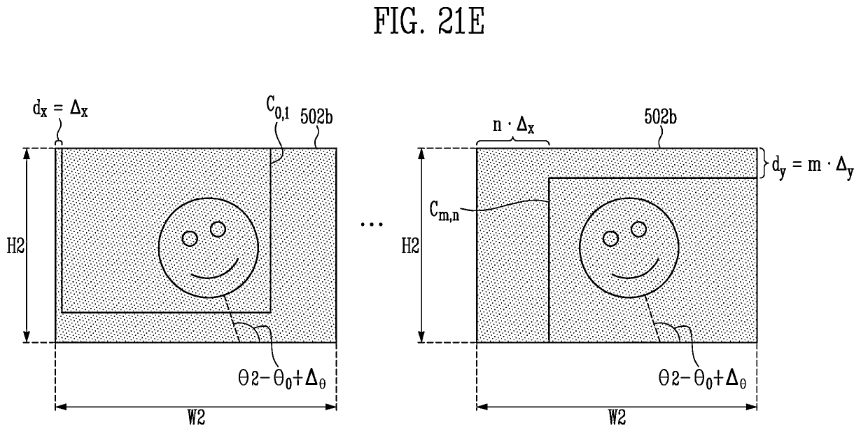

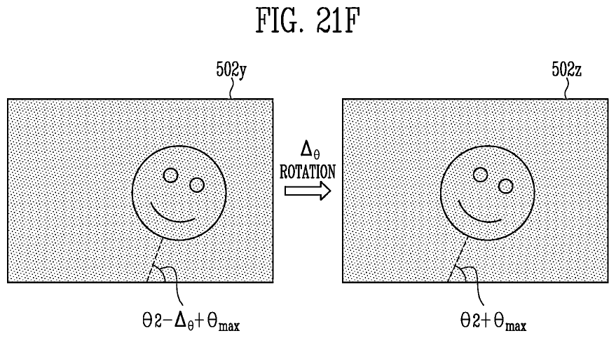

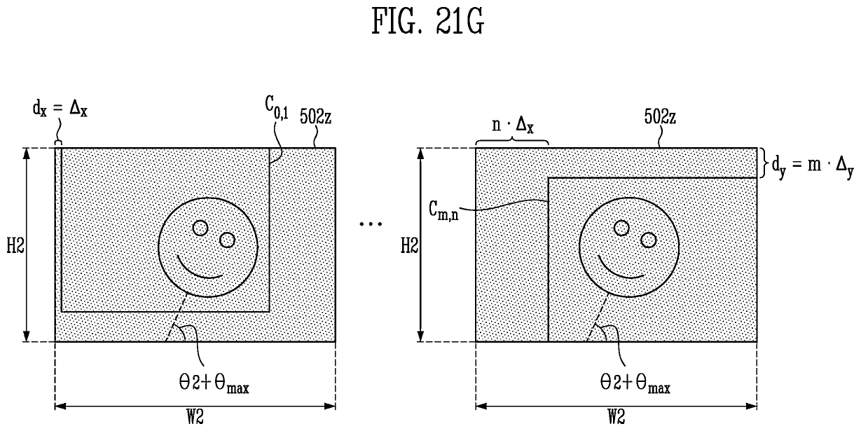

FIGS. 21A to 21G are schematic diagrams illustrating an operation of an image preprocessing device 510 according to an embodiment.

Referring to FIG. 21A, the reference image data C_{REF} may be generated based on the first image data 501. The image preprocessing device 510 may generate the reference image data C_{REF} by cropping a partial area of the received first image data 501.

Referring to FIG. 21B, second image data 502a rotated by an initialization angle −θ₀ based on the second image data 502 may be generated. Accordingly, the angle between the line crossing the exact center of the object OBJ in the capture area of the second image data 502 and the horizontal line based on the capture area of the second image data 502 may change from “θ2” to “θ2−θ₀”. For example, a value corresponding to blank spaces that occurs in the second image data 502a as the second image data 502 rotates by the initialization angle −θ₀ may be filled with an arbitrary data value. In an embodiment, a value corresponding to black may be applied to the blank spaces occurring in the second image data 502a. In another embodiment, a value corresponding to white may be applied to the blank spaces occurring in the second image data 502a. In still another embodiment, an average value of all pixel data values of the second image data 502 may be applied to the blank spaces occurring in the second image data 502a.

Referring to FIG. 21C, the plurality of crop image data may be generated using the rotated second image data 502a generated by FIG. 21B. For example, the plurality of crop image data may be generated in the method equal to that described with reference to FIGS. 15A to 15F.

Referring to FIG. 21D, second image data 502b may be generated by rotating the second image data 502a described with reference to FIG. 21B by a unit angle Δθ. Accordingly, the angle between the line crossing the exact center of the object OBJ in the capture area of the second image data 502 and the horizontal line based on the capture area of the second image data 502 may change from “θ2” to “θ2−θ₀+Δθ.”

Referring to FIG. 21E, the plurality of crop image data may be generated using the rotated second image data 502b generated by FIG. 21D. For example, the plurality of crop image data may be generated in the method equal to that described with reference to FIGS. 15A to 15F.

In such a method, the plurality of crop image data may be generated based on each of the second image data obtained by additionally rotating the second image data by the unit angle Δθ.

Referring to FIG. 21F, second image data 502z obtained by rotating second image data 502y by the unit angle Δθ may be generated. Accordingly, the angle between the line crossing the exact center of the object OBJ in the capture area of the second image data 502 and the horizontal line based on the capture area of the second image data 502 may change from “θ2−Δθ+θₘₐₓ” to “θ2+θₘₐₓ”. “θₘₐₓ” may be a selected value and may be a rotation angle that rotates the second image data to a maximum.

Referring to FIG. 21G, the plurality of crop image data may be generated using the rotated second image data 502z generated by FIG. 21F. For example, the plurality of crop image data may be generated in the method equal to that described with reference to FIGS. 15A to 15F.

Referring to FIGS. 21A to 21G, the second image data may be rotated by the initial angle “−θ₀”, and then additionally rotated by the unit angle Δθ, and the maximum rotation angle may become “θₘₐₓ”. For example, the plurality of crop image data may be generated while rotating the second image data by the unit angle Δθ in a rotation angle range of −θ₀ to θₘₐₓ.

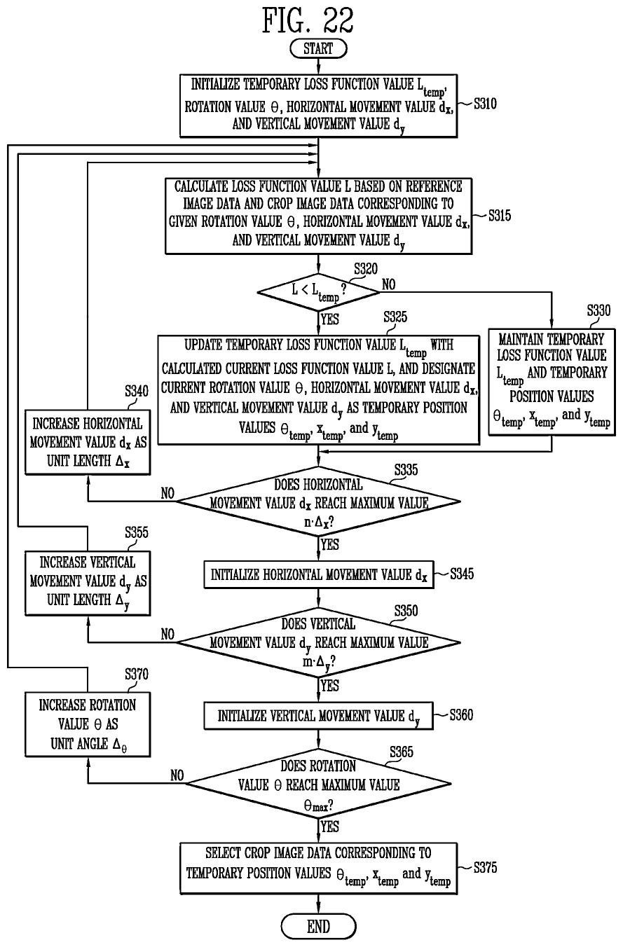

FIG. 22 is a flowchart illustrating another embodiment of the step S140 of FIG. 17. In a description of FIG. 22, a content similar to (or same as) the description of FIG. 18A is omitted.

Referring to FIG. 22, in the step S310, the temporary loss function value Lₜₑₘₚ, the rotation angle θ, the horizontal movement value dₓ, and the vertical movement value d_{y} may be initialized. The rotation angle θ may be a value for the rotation angle of the second image data described with reference to FIGS. 21B, 21D, and 21F. Referring to FIG. 21B, the rotation angle θ of the second image data may be initialized to the initialization angle −θ₀. For example, the horizontal movement value dₓ and the vertical movement value d_{y} may correspond to the horizontal movement value dₓ and the vertical movement value d_{y} of the crop image data described with reference to FIGS. 15B to 15F. In the step S210, the horizontal movement value dₓ and the vertical movement value d_{y} may be initialized to 0, and the rotation angle θ may be initialized to the initialization angle −θ₀.

Thereafter, in the step S315, the value of the loss function may be calculated based on the crop image data corresponding to the given rotation angle θ, horizontal movement value dₓ, and vertical movement value d_{y}, and the reference image data C_{REF} generated in the step S120 of FIG. 17.

In the step S320, the calculated loss function value L and the temporary loss function value Lₜₑₘₚ may be compared. Since the temporary loss function value Lₜₑₘₚ initialized in the step S310 is a relatively large value, it may be determined that the calculated loss function value L is less than the temporary loss function value Lₜₑₘₚ in the step S320.

In case that the calculated loss function value L is less than the temporary loss function value Lₜₑₘₚ (S320: Yes), the temporary loss function value Lₜₑₘₚ may be updated with the loss function value L calculated in the step S315. In case that the calculated loss function value L is less than the temporary loss function value Lₜₑₘₚ, the current rotation angle θ, horizontal movement value dₓ, and vertical movement value d_{y} may be designated as the temporary position values θₜₑₘₚ, xₜₑₘₚ, and yₜₑₘₚ. The temporary position values θₜₑₘₚ, xₜₑₘₚ, and yₜₑₘₚ may be a variable for temporarily maintaining the rotation angle θ, the horizontal movement value dₓ, and the vertical movement value d_{y} corresponding to the currently updated temporary loss function value Lₜₑₘₚ.

In case that the calculated loss function value L is greater than or equal to the temporary loss function value Lₜₑₘₚ (S320: No), the temporary loss function value Lₜₑₘₚ may not be updated. Since this means that the loss function value L calculated in the step S315 is not a minimum loss function value, the loss function value L calculated in the step S215 is discarded. For example, the temporary loss function value Lₜₑₘₚ and the temporary position values θₜₑₘₚ, xₜₑₘₚ, and yₜₑₘₚ corresponding thereto may be maintained.

Thereafter, in the step S335, it may be determined whether the horizontal movement value dₓ reaches the maximum value “n·Δₓ”. In case that the horizontal movement value dₓ does not reach the maximum value “n·Δₓ” in a state in which the vertical movement value d_{y} is 0 (S335: No), the method may proceed to the step S340.

In the step S340, the horizontal movement value dₓ may be increased by the unit length Δₓ, and the method may proceed to the step S315. Accordingly, calculating the loss function L based on the reference image data C_{REF} and the crop image data corresponding to the increased vertical movement value dₓ (S315), and comparing the calculated loss function L with the temporary loss function value Lₜₑₘₚ may be repeatedly performed. In case that the calculated loss function value L is less than the temporary loss function value Lₜₑₘₚ, the step S325 may be performed. In case that the calculated loss function value L is greater than or equal to the temporary loss function value Lₜₑₘₚ (S320: No), the temporary loss function value Lₜₑₘₚ may not be updated S330.

As a result of the determination of the step S335, in case that the horizontal movement value dₓ reaches the maximum value “n·Δₓ” (S335: Yes), the vertical movement value d_{y} may be required to be increased by the unit length Δ_{y}. Therefore, in case that the horizontal movement value dₓ reaches “n·Δₓ” which is a maximum value (S335: Yes), the method may proceed to the step S345.

In the step S345, the horizontal movement value dₓ may be initialized to 0. Thereafter, the method may proceed to the step S350 to determine whether the current vertical movement value d_{y} reaches the maximum value “m·Δ_{y}”. In a case where the vertical movement value d_{y} does not reach the maximum value “m·Δ_{y}” (S350: No), this means that a process of calculating the loss function value L based on each of all generated crop image data C_{0,0} to C_{m,n} and the reference image data C_{REF} and comparing the loss function value L with the temporary loss function value Lₜₑₘₚ at the currently given rotation angle θ is not yet completed. For example, in order to calculate the loss function L for crop image data corresponding to a first column of a next row and the reference image data C_{REF} and to compare the loss function L with the temporary loss function value Lₜₑₘₚ, the vertical movement value d_{y} may be required to be increased by the unit length Δ_{y}. Therefore, in case that the vertical movement value d_{y} does not reach the maximum value “m·Δ_{y}” (S350: No), the method may proceed to the step S355.

In the step S355, the vertical movement value d_{y} may be increased by the unit length Δₓ, and the method may proceed to the step S315. Accordingly, calculating the loss function L based on the crop image data corresponding to the increased vertical movement value d_{y} and the horizontal movement value dₓ initialized to 0 and the reference image data C_{REF} (S315), and comparing the calculated loss function L with the temporary loss function value Lₜₑₘₚ (S320) may be repeatedly performed.

As a result of the determination of the step S350, in case that the vertical movement value d_{y} reaches the maximum value “m·Δ_{y}” (S350: Yes), the rotation angle θ may be required to be increased by the unit angle Δθ. Therefore, in case that the vertical movement value d_{y} reaches the maximum value “m·Δ_{y}” (S350: Yes), the method may proceed to the step S360.

In the step S360, the vertical movement value d_{y} may be initialized to 0. Thereafter, the method may proceed to the step S365 to determine whether the current rotation angle θ reaches the maximum value “θₘₐₓ”. In a case where the rotation angle θ does not reach the maximum value “θₘₐₓ” (S365: No), this means that a process of calculating the loss function value L based on each of crop image data generated in correspondence with all rotation angles and the reference image data C_{REF} and comparing the loss function value L with the temporary loss function value Lₜₑₘₚ is not yet completed. For example, in order to calculate the loss function L for each of crop image data corresponding to a next rotation angle and the reference image data C_{REF} and to compare the loss function L with the temporary loss function value Lₜₑₘₚ, the rotation angle θ may be required to be increased by the unit angle Δθ. Therefore, in case that the rotation angle θ does not reach the maximum value “θₘₐₓ” (S365: No), the method may proceed to the step S370.

In the step S370, the rotation angle θ may be increased by the unit angle Δθ, and the method may proceed to the step S315. Accordingly, the steps S315, S320, S325, S330, S335, S340, S345, S350, S355, and S360 may be repeatedly performed.

As a result of the determination of the step S365, in a case where the rotation angle θ reaches the maximum value “θₘₐₓ” (S365: Yes), this means that a process of calculating the loss function value L based on each of all crop image data C_{0,0} to C_{m,n} and reference image data C_{REF} and comparing the loss function value L with the temporary loss function value Lₜₑₘₚ is completed with respect to the entire rotation angle range of −θ₀ to θₘₐₓ. For example, the smallest value among all calculated loss function values L may be designated as the temporary loss function value Lₜₑₘₚ, and the rotation angle θ, the horizontal movement value dₓ, and the vertical movement value d_{y} corresponding to the smallest value among all calculated loss function values L may be designated as the temporary position values θₜₑₘₚ, xₜₑₘₚ, and yₜₑₘₚ. Therefore, the crop image data corresponding to the temporary position values θₜₑₘₚ, xₜₑₘₚ, and yₜₑₘₚ may be selected (S375).

Referring to the flowchart shown in FIG. 22A, the step S140 may include a small loop configured by a branch that returns to the step S315 in case that it is determined as “No” in the step S335, an intermediate loop configured by a branch that returns to the step S315 in case that it is determined as “No” in the step S350, and a large loop configured by a branch that returns to the step 315 in case that it is determined as “No” in the step S365. As the small loop is repeatedly performed, an operation of searching for the minimum loss function value L may be performed while calculating the loss function value L based on the crop image data and the reference image data C_{REF} and comparing the loss function value L with the temporary loss function value Lₜₑₘₚ as a column number increases in a given rotation angle and a given row. For example, as the intermediate loop is repeatedly performed, an operation of searching for the minimum loss function value L may be performed while calculating the loss function value L based on the crop image data and the reference image data C_{REF} and comparing the loss function value L with the temporary loss function value Lₜₑₘₚ while increasing a row number at a given rotation angle. For example, as the large loop is repeatedly performed, an operation of searching for the minimum loss function value L may be performed while calculating the loss function value L based on the crop image data and the reference image data C_{REF} and comparing the loss function value L with the temporary loss function value Lₜₑₘₚ while increasing the rotation angle.

The drawings referred to so far and the detailed description of the disclosure described herein are merely examples of the disclosure, are used for merely describing the disclosure, and are not intended to limit the meaning and the scope of the disclosure described in claims. Therefore, those skilled in the art will understand that various modifications and equivalent other embodiments are possible from these. Thus, the true scope of the disclosure should be determined by the technical spirit of the appended claims.

What is claimed is:

1. An image preprocessing method generating an image data pair for image restoration training, the image preprocessing method comprising:
receiving first image data and second image data;
generating reference image data based on the first image data;
generating a plurality of crop image data based on the second image data;
selecting crop image data based on a smallest loss function value among loss function values generated based on each of the reference image data and the plurality of crop image data; and
outputting the reference image data and the selected crop image data as the image data pair.

2. The image preprocessing method of claim 1, wherein the loss function values are calculated by Equation 1 below:
$$L 1 ( D 1 , D 2 ) = {\sum }_{x = 1}^{N} {\sum }_{y = 1}^{M} {( D 1 ( x , y ) - D 2 ( x , y ) )}^{2}$$
wherein D1 indicates the reference image data, D2 indicates one of the plurality of crop image data, M indicates a height of the reference image data, N indicates a width of the reference image data, D1(x,y) indicates a data value of coordinates (x, y) in the reference image data, D2(x,y) indicates a data value of the coordinates (x, y) in one of the plurality of crop image data, L1(D1,D2) indicates a loss function value generated based on one of the reference image data and the plurality of crop image data, and M and N are natural numbers of 2 or more.

3. The image preprocessing method of claim 1, wherein the loss function values are calculated by Equation 2 below:
$$L 2 ( D 1 , D 2 ) = {\sum }_{u = 1}^{N} {\sum }_{v = 1}^{M} \vert {F}_{D 1} ( u , v ) - {F}_{D 2} ( u , v ) \vert$$
wherein D1 indicates the reference image data, D2 indicates one of the plurality of crop image data, M indicates a height of the reference image data, N indicates a width of the reference image data, F_{D1}(u,v) indicates a data value of coordinates (u, v) in Fourier transform of the reference image data, F_{D2}(x,y) indicates a data value of the coordinates (u, v) in the Fourier transform of one of the plurality of crop image data, L2(D1,D2) indicates a loss function value generated based on one of the reference image data and the plurality of crop image data, and M and N are natural numbers of 2 or more.

4. The image preprocessing method of claim 1, wherein the loss function values are calculated by Equation 3 below:
$$L 3 ( D 1 , D 2 ) = {\sum }_{u = 1}^{N} {\sum }_{v = 1}^{M} \vert ∠ {F}_{D 1} ( u , v ) - ∠ {F}_{D 2} ( u , v ) \vert$$
wherein D1 indicates the reference image data, D2 indicates one of the plurality of crop image data, M indicates a height of the reference image data, N indicates a width of the reference image data, F_{D1}(u,v) indicates a data value of coordinates (u, v) in Fourier transform of the reference image data, F_{D2}(x,y) indicates a data value of the coordinates (u, v) in the Fourier transform of one of the plurality of crop image data, L3(D1,D2) indicates a loss function value generated based on one of the reference image data and the plurality of crop image data, and M and N are natural numbers of 2 or more.

5. The image preprocessing method of claim 1, wherein the loss function values are calculated by Equation 4 below:
$$L 4 ( D 1 , D 2 ) = {λ}_{1} \cdot L 1 ( D 1 , D 2 ) + {λ}_{2} \cdot L 2 ( D 1 , D 2 ) + {λ}_{3} \cdot L 3 ( D 1 , D 2 )$$
wherein D1 indicates the reference image data, D2 indicates one of the plurality of crop image data, M indicates a height of the reference image data, N indicates a width of the reference image data, D1(x,y) indicates a data value of coordinates (x, y) in the reference image data, D2(x,y) indicates a data value of the coordinates (x, y) in one of the plurality of crop image data, F_{D1}(u,v) indicates a data value of coordinates (u, v) in Fourier transform of the reference image data, F_{D2}(x,y) indicates a data value of the coordinates (u, v) in the Fourier transform of one of the plurality of crop image data, L3(D1,D2) indicates a loss function value generated based on one of the reference image data and the plurality of crop image data, M and N are natural numbers of 2 or more, and each of λ₁, λ₂, and λ₃ is a selected real number.

6. The image preprocessing method of claim 1, wherein the selecting of the crop image data based on the smallest loss function value among the loss function values generated based on each of the reference image data and the plurality of crop image data comprises:
initializing a temporary loss function value, a horizontal movement values, and a vertical movement value;
calculating the loss function value based on the reference image data and crop image data corresponding to given horizontal movement value and vertical movement value among the plurality of crop image data; and
determining whether the loss function value is less than the temporary loss function value.

7. The image preprocessing method of claim 6, wherein the selecting of the crop image data based on the smallest loss function value among the loss function values generated based on each of the reference image data and the plurality of crop image data further comprises:
updating the temporary loss function value with the calculated loss function value in case that the calculated loss function value is less than the temporary loss function value, and designating a horizontal movement value and a vertical movement value corresponding to the calculated loss function value as a temporary position value.

8. The image preprocessing method of claim 7, wherein the selecting of the crop image data based on the smallest loss function value among the loss function values generated based on each of the reference image data and the plurality of crop image data further comprises:
increasing the horizontal movement value by a first unit length in case that the horizontal movement value does not reach a maximum value;
increasing the vertical movement value by a unit length; and
calculating the loss function value based on the reference image data and crop image data corresponding to given horizontal movement value and vertical movement value among the plurality of crop image data.

9. The image preprocessing method of claim 7, wherein the selecting of the crop image data based on the smallest loss function value among the loss function values generated based on each of the reference image data and the plurality of crop image data further comprises:
initializing the horizontal movement value in case that the horizontal movement value reaches a maximum value.

10. The image preprocessing method of claim 9, wherein the selecting of the crop image data based on the smallest loss function value among the loss function values generated based on each of the reference image data and the plurality of crop image data further comprises:
increasing the vertical movement value by a second unit length in case that the vertical movement value does not reach a maximum value; and
calculating the loss function value based on the reference image data and crop image data corresponding to given horizontal movement value and vertical movement value among the plurality of crop image data.

11. The image preprocessing method of claim 9, wherein the selecting of the crop image data based on the smallest loss function value among the loss function values generated based on each of the reference image data and the plurality of crop image data further comprises:
selecting crop image data corresponding to the temporary position value in case that the vertical movement value reaches a maximum value.

12. The image preprocessing method of claim 11, wherein the selecting of the crop image data based on the smallest loss function value among the loss function values generated based on each of the reference image data and the plurality of crop image data comprises:
initializing a temporary loss function value, a rotation angle, a horizontal movement value, and a vertical movement value;
calculating the loss function value based on the reference image data and crop image data corresponding to given rotation angle, horizontal movement value, and vertical movement value among the plurality of crop image data; and
determining whether the calculated loss function value is less than the temporary loss function value.

13. The image preprocessing method of claim 12, wherein the selecting of the crop image data based on the smallest loss function value among the loss function values generated based on each of the reference image data and the plurality of crop image data further comprises:
updating the temporary loss function value with the calculated loss function value in case that the calculated loss function value is less than the temporary loss function value, and designating a rotation angle, a horizontal movement value, and a vertical movement value corresponding to the calculated loss function value as a temporary position value.

14. The image preprocessing method of claim 13, wherein the selecting of the crop image data based on the smallest loss function value among the loss function values generated based on each of the reference image data and the plurality of crop image data further comprises:
increasing the horizontal movement value by a first unit length in case that the horizontal movement value does not reach a maximum value;
increasing the vertical movement value by a unit length; and
calculating the loss function value based on the reference image data and crop image data corresponding to given horizontal movement value and vertical movement value among the plurality of crop image data.

15. The image preprocessing method of claim 13, wherein the selecting of the crop image data based on the smallest loss function value among the loss function values generated based on each of the reference image data and the plurality of crop image data further comprises:
initializing the horizontal movement value in case that the horizontal movement value reaches a maximum value.

16. The image preprocessing method of claim 15, wherein the selecting of the crop image data based on the smallest loss function value among the loss function values generated based on each of the reference image data and the plurality of crop image data further comprises:
increasing the vertical movement value by a second unit length in case that the vertical movement value does not reach a maximum value; and
calculating the loss function value based on the reference image data and crop image data corresponding to given horizontal movement value and vertical movement value among the plurality of crop image data.

17. The image preprocessing method of claim 15, wherein the selecting of the crop image data based on the smallest loss function value among the loss function values generated based on each of the reference image data and the plurality of crop image data further comprises:
initializing the vertical movement value in case that the vertical movement value reaches a maximum value.

18. The image preprocessing method of claim 17, wherein the selecting of the crop image data based on the smallest loss function value among the loss function values generated based on each of the reference image data and the plurality of crop image data further comprises:
increasing the rotation angle by a unit angle in case that the rotation angle does not reach a maximum value; and
calculating the loss function value based on the reference image data and crop image data corresponding to given horizontal movement value and vertical movement value among the plurality of crop image data.

19. The image preprocessing method of claim 17, wherein the selecting of the crop image data based on the smallest loss function value among the loss function values generated based on each of the reference image data and the plurality of crop image data further comprises:
selecting crop image data corresponding to the temporary position value in case that the rotation angle reaches a maximum value.
